(19) United States
(12) Patent Application Publication
(10) Pub. No.: US 2016/0266646 A1
(43) Pub. Date: Sep. 15, 2016

(54) DRIVE CONTROL APPARATUS, ELECTRONIC DEVICE AND DRIVE CONTROLLING METHOD

(71) Applicant: FUJITSU LIMITED, Kawasaki-shi (JP)

(72) Inventors: Yuichi Kamata, Isehara (JP); yasuhiro endo, Ebina (JP); Akinori Miyamoto, Sagamihara (JP); Kiyoshi Taninaka, Ebina (JP)

(73) Assignee: FUJITSU LIMITED, Kawasaki-shi (JP)

(21) Appl. No.: 15/160,633

(22) Filed: May 20, 2016

Related U.S. Application Data
(63) Continuation of application No. PCT/JP2014/053470, filed on Feb. 14, 2014.

(51) Int. Cl. G06F 3/01; G06F 3/041; G06F 3/044

(52) U.S. Cl. CPC G06F 3/016; G06F 3/044; G06F 3/0416; G06F 3/0412

(57) ABSTRACT

A drive control apparatus that drives a vibrating element of an electronic device including a display part, a top panel disposed on a display surface side of the display part and having a manipulation input surface, a position detector detecting a position of a manipulation input performed on the manipulation input surface, and the vibrating element generating a vibration in the manipulation input surface, including a drive controller configured to drive the vibrating element by using a drive signal causing the vibrating element to generate a natural vibration in ultrasound-frequency-band in the manipulation input surface, the drive controller being configured to drive the vibrating element so as to switch the natural vibration between a strong level and a weak level for a designated period of time when a travel distance of a position of the manipulation input performed onto the manipulation input surface reaches a designated travel distance.

### CROSS-REFERENCE TO RELATED APPLICATION

This application is a continuation application of International Application PCT/JP2014/053470 filed on Feb. 14, 2014 and designated the U.S., the entire contents of which are incorporated herein by reference.

### FIELD

The embodiment discussed herein is related to a drive control apparatus, an electronic device and a drive controlling method.

### BACKGROUND

There has been a tactile sensation producing apparatus which includes a display, a contact detector that detects a contact state of user's manipulate operation to the display and a haptic vibration generating part which generates haptic vibration that gives a designated sensation to the user's body-part contacting the display (for example, see Patent Document 1).

The tactile sensation producing apparatus further includes a vibration waveform data generating means which generates a waveform data based on a detected result of the contact detector. The waveform data is used for generating the haptic vibration. The tactile sensation producing apparatus further includes an ultrasound modulating means which performs a modulating process to the waveform data by utilizing an ultrasound as a carrier wave and outputs an ultrasound signal generated by the modulating process to the haptic vibration generating means as a signal used for generating the haptic vibration.

The ultrasound modulating means performs either a frequency modulation or a phase modulation. The ultrasound modulating means further performs an amplitude modulation.

However, a ultrasound frequency used in the conventional tactile sensation producing apparatus may be any frequency as long as the frequency is higher than that of an audio frequency (about 20 kHz). No specific setting is made to the ultrasound frequency. Accordingly, the tactile sensation producing apparatus cannot provide a fine or crispy tactile sensation to the user.

### RELATED-ART DOCUMENTS

### Patent Documents

### [Patent Document 1] Japanese Laid-open Patent Publication No. 2010-231609

### SUMMARY

According to an aspect of the present application, there is provided drive control apparatus that drives a vibrating element of an electronic device including a display part, a top panel disposed on a display surface side of the display part and having a manipulation input surface, a position detector detecting a position of a manipulation input performed on the manipulation input surface, and the vibrating element generating a vibration in the manipulation input surface, including a drive controller configured to drive the vibrating element by using a drive signal causing the vibrating element to generate a natural vibration in an ultrasound-frequency-band in the manipulation input surface, the drive controller being configured to drive the vibrating element so as to switch the natural vibration between a strong level and a weak level for a designated period of time when a travel distance of a position of the manipulation input performed onto the manipulation input surface reaches a designated travel distance.

The object and advantages of the disclosure will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is a diagram illustrating an electronic device according to a first embodiment in perspective view;

FIG. 2 is a diagram illustrating the electronic device of the first embodiment in plan view;

FIG. 3 is a diagram illustrating a cross-sectional view of the electronic device taken along a line A-A of FIG. 2;

FIG. 4 is a diagram illustrating crests and troughs of standing wave formed in parallel with a short side of a top panel included in standing waves generated in the top panel by the natural vibration at the ultrasound-frequency-band;

FIG. 5 is a diagram illustrating cases where a kinetic friction force applied to the fingertip varies when the natural vibration at the ultrasound-frequency-band is generated in the top panel of the electronic device;

FIG. 6 is a diagram illustrating a configuration of the electronic device according to the first embodiment;

FIG. 7 is a diagram illustrating a state where the electronic device of the first embodiment displays various commercial items on a display panel;

FIG. 8 is a diagram illustrating a list (an enumeration) of the commercial items displayed on the electronic device according to the first embodiment;

FIG. 9 is a diagram illustrating an operational example of the electronic device according to the first embodiment;

FIG. 10 is a diagram illustrating a flow chart executed by a drive controller according to the first embodiment;

FIG. 11 is a diagram illustrating an operational example of the electronic device according to a first variational example of the first embodiment;

FIG. 12 is a diagram illustrating a cross section of the electronic device according to a second variational example of the first embodiment;

FIG. 13 is a diagram illustrating a cross section of a touch-pad of an electronic device according to a third variational example of the first embodiment;

FIG. 14 is a diagram illustrating the electronic device according to the third variational example of the first embodiment;

FIG. 15 is a diagram illustrating an electronic device according to a second embodiment in plan view;

FIG. 16 is a diagram illustrating coordinate data used in the electronic device 400 of the second embodiment;

FIG. 17 is a diagram illustrating a flowchart executed by a drive controller of a drive control apparatus included in the electronic device according to the second embodiment;

FIG. 18 is a diagram illustrating an electronic device according to a third embodiment in plan view;

FIG. 19 is a diagram illustrating an operational example of the electronic device according to the third embodiment;

FIG. 20 is a diagram illustrating commercial item data used in the electronic device according to the third embodiment;

FIG. 21 is a diagram illustrating a flowchart executed by the drive controller of the drive control apparatus included in the electronic device according to the third embodiment;

FIG. 22 is a diagram illustrating an electronic device according to a variational example of the third embodiment; and

FIG. 23 is a diagram illustrating a system of a fourth embodiment.

### DESCRIPTION OF EMBODIMENT

Hereinafter, an embodiment to which a drive control apparatus, an electronic device and a drive controlling method of the present invention are applied will be described.

### First Embodiment

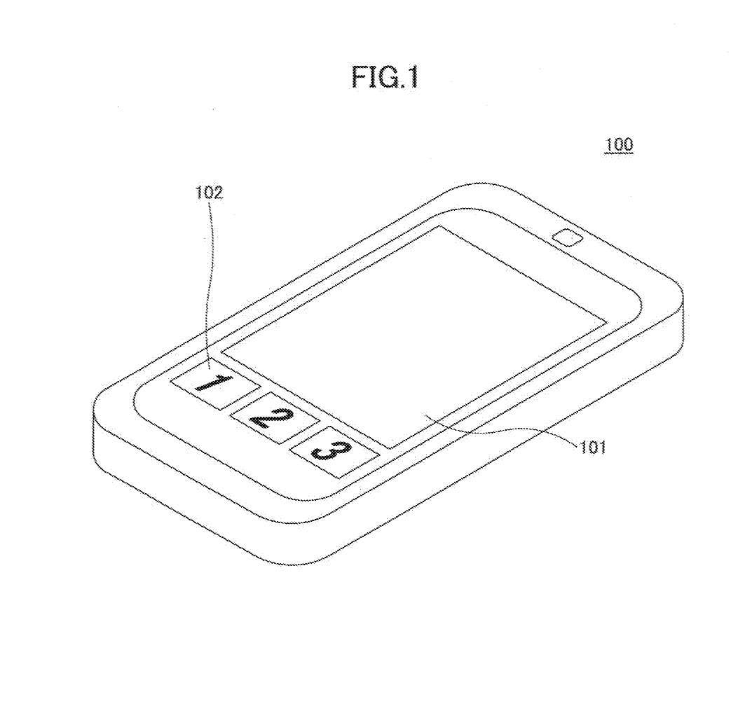

FIG. 1 is a diagram illustrating an electronic device 100 according to the embodiment in perspective view.

The electronic device 100 is a smart phone or a tablet computer that includes a touch panel as a manipulation input part, for example. The electronic device 100 may be any device as long as the device includes a touch panel as a manipulation input part. Accordingly, the electronic device 100 may be a device such as a handy type information terminal device, an Automatic Teller Machine (ATM) placed at a specific location or the like, for example.

In a manipulation input part 101 of the electronic device 100, a display panel is disposed under a touch panel, and various types of operating portions such as a button 102 and the like and various types of images are displayed on the display panel.

A user of the electronic device 100 touches the manipulation input part 101 in order to manipulate (operate) the GUI input part 102 with a fingertip under normal conditions.

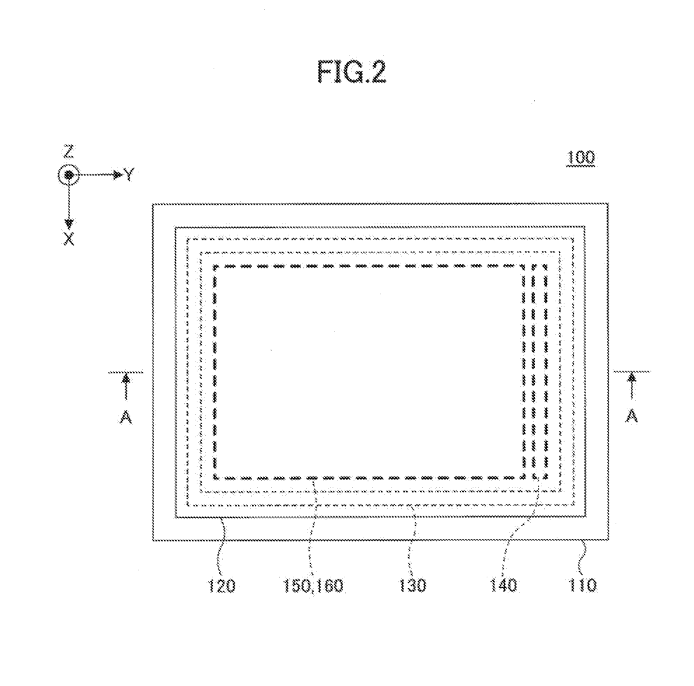

Hereinafter, a detail configuration of the electronic device 100 will be described with reference to FIG. 2.

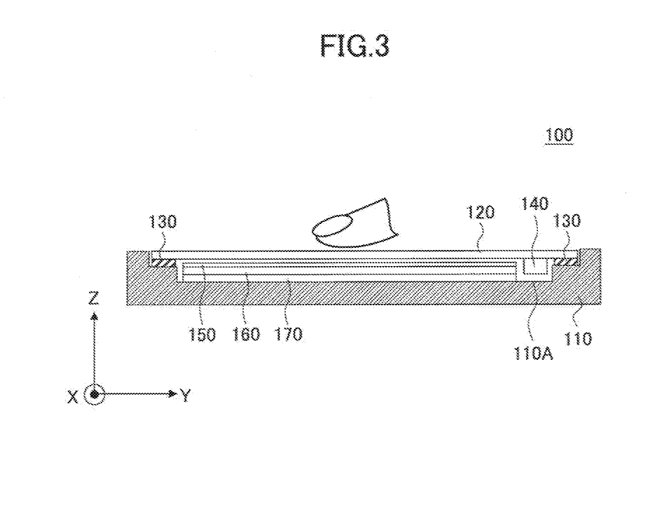

FIG. 2 is a diagram illustrating the electronic device 100 of the embodiment in plan view. FIG. 3 is a diagram illustrating a cross-sectional view of the electronic device 100 taken along a line A-A of FIG. 2. An XYZ coordinate system as an orthogonal coordinate system is defined in FIGS. 2 and 3.

The electronic device 100 includes a housing 110, a top panel 120, a double-faced adhesive tape 130, a vibrating element 140, a touch panel 150, a display panel 160 and a substrate 170.

The housing 110 is made of a plastic, for example. As illustrated in FIG. 3, the substrate 170, the display panel 160 and the touch panel 150 are contained in a concave portion 110A of the housing 110, and a top panel 120 is adhered onto the housing 110 by the double-faced adhesive tape 130.

The top panel 120 is a plate-shaped member having a rectangular shape in plan view and is made of a transparent glass or a reinforced plastic such as polycarbonate. A surface of the top panel 120 which is located on a positive side in Z axis direction is one example of a manipulation input surface to which the user of the electronic device 100 performs a manipulation input.

The vibrating element 140 is bonded on a surface of the top panel 120 which is located on a negative side in Z axis direction, and the top panel 120 is adhered to the housing 110 by the double-faced adhesive tape 130. Herein, the double-faced adhesive tape 130 is not necessarily a rectangular-ring-shaped member in plan view as illustrated in FIG. 3, as long as the double-faced adhesive tape 130 can adhere four corners of the top panel 120 to the housing 110.

The touch panel 150 is disposed on the negative side in Z axis direction of the top panel 120. The top panel 120 is provided for the sake of protecting the surface of the touch panel 150. Another panel, protection film or the like may be provided onto the surface of the top panel 120.

In a state where the vibrating element 140 is bonded onto the surface of the top panel 120 located on the negative side in Z axis direction, the top panel 120 vibrates if the vibrating element 140 is being driven. In the first embodiment, a standing wave is generated at the top panel 120 by causing the top panel 120 to vibrate at a natural vibration frequency (natural resonance frequency or eigenfrequency) of the top panel 120. Since the vibrating element 140 is bonded to the top panel 120, it is preferable to determine the natural vibration frequency in consideration of a weight of the vibrating element 140 of the like, in a practical manner.

The vibrating element 140 is bonded on the surface of the top panel 120 which is located on the negative side in Z axis direction at a location along the short side extending in X axis direction at a positive side in Y axis direction. The vibrating element 140 may be any element as long as it can generate vibration at an ultrasound-frequency-band. A piezoelectric element such as a piezo element is used as the vibrating element 140, for example.

The vibrating element 140 is driven in accordance with a drive signal output from the drive controller which will be described later. An amplitude (intensity) and a frequency of the vibration output from the vibrating element 140 is set (determined) by the drive signal. An on/off action of the vibrating element 140 is controlled in accordance with the drive signal.

The ultrasound-frequency-band is a frequency band which is higher than or equal to about 20 kHz, for example. According to the electronic device 100 of the embodiment, the frequency at which the vibrating element 140 vibrates is equal to a number of vibration (frequency) of the top panel 120. Accordingly, the vibrating element 140 is driven in accordance with the drive signal so that the vibrating element 140 vibrates at a number of natural vibration (natural vibration frequency) of the top panel 120.

The touch panel 150 is disposed on upper side (positive side in Z axis direction) of the display panel 160 and is disposed on lower side (negative side in Z axis direction) of the top panel 120. The touch panel 150 is one example of a coordinate detector which detects a position at which the user of the electronic device 100 touches the top panel 120. Hereinafter, the position is referred to as a position of the manipulation input.

The display panel 160 disposed under the touch panel 150 displays various GUI button(s) or the like. Hereinafter, the various GUI button(s) or the like is referred to as a GUI input part. The user of the electronic device 100 touches the top panel 120 with the fingertip in order to manipulate (operate) the GUI input part under normal conditions.

The touch panel 150 may be a coordinate detector which detects a position which the user of the electronic device 100 touches on the top panel 120, for example. The touch panel 150 may be a capacitance type coordinate detector or a resistance film type coordinate detector, for example. Hereinafter, the embodiment in which the touch panel 150 is the capacitance type coordinate detector will be described. In a case where the touch panel 150 is the capacitance type, the touch panel 150 can detect the manipulation input performed onto the top panel 120 even if there is a clearance gap between the touch panel 150 and the top panel 120.

Although the top panel 120 is disposed on the manipulation input surface side of the touch panel 150 in the present embodiment, the top panel 120 may be integrated with the touch panel 150. In this case, the surface of the touch panel 150 is equal to the surface of the top panel 120 as illustrated in FIGS. 2 and 3, and the surface of the touch panel 150 becomes the manipulation input surface. Otherwise, the top panel 120 as illustrated in FIGS. 2 and 3 may be omitted. In this case, the surface of the touch panel 150 constitutes the manipulation input surface. In this case, the vibrating element 140 vibrates the manipulation input surface at a natural vibration frequency of a member having the manipulation input surface.

In a case where the touch panel 150 is the capacitance type, the touch panel 150 may be disposed on the top panel 120. In this case, the surface of the touch panel 150 constitutes the manipulation input surface. In a case where the touch panel 150 is the capacitance type, the top panel 120 as illustrated in FIGS. 2 and 3 may be omitted. In this case, the surface of the touch panel 150 constitutes the manipulation input surface. In this case, the vibrating element 140 vibrates the manipulation input surface at a natural vibration frequency of a member having the manipulation input surface.

The display panel 160 is a display part which displays a picture image. The display panel 160 may be a liquid crystal display panel, an organic Electroluminescence (EL) panel or the like, for example. The display panel 160 is disposed in the concave portion 110A of the housing 110 and is disposed on (the positive side in Z axis direction of) the substrate 170.

The display panel 160 is driven by a driver Integrated Circuit (IC) and displays the GUI input part, the picture image, characters, symbols, graphics or the like in accordance with an operating state of the electronic device 100.

The substrate 170 is disposed in the concave portion 110A of the housing 110. The display panel 160 and the touch panel 150 are disposed on the substrate 170. The display panel 160 and the touch panel 150 are fixed to the substrate 170 and the housing 110 by a holder or the like (not shown).

On the substrate 170, a drive control apparatus which will be described hereinafter and circuits or the like that are necessary for driving the electronic device 100 are mounted.

In the electronic device 100 having the configuration as described above, when the user touches the top panel 120 with the fingertip and a move of the fingertip is detected, the drive controller mounted on the substrate 170 drives the vibrating element 140 so that the top panel 120 vibrates at a frequency in the ultrasound-frequency-band. The frequency in the ultrasound-frequency-band is a resonance frequency of a resonance system including the top panel 120 and the vibrating element 140. The standing wave is generated at the top panel 120 at the frequency.

The electronic device 100 generates the standing wave at the ultrasound-frequency-band at the top panel 120 and provides a tactile sensation (haptic sensation) to the user through the top panel 120.

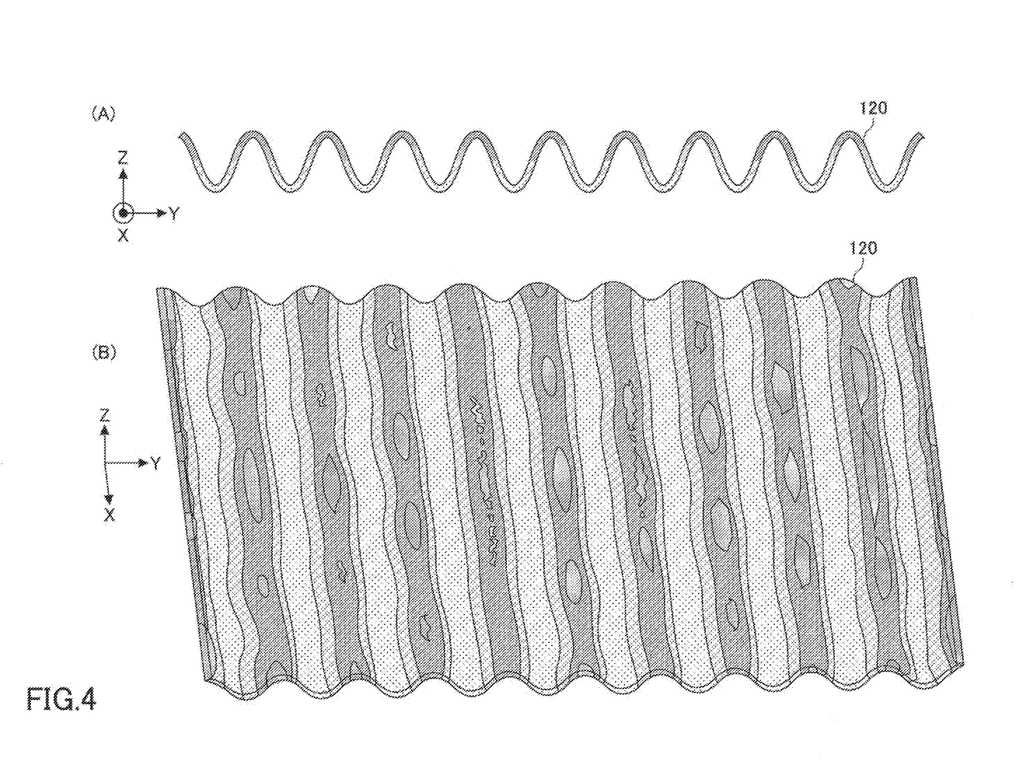

Next, the standing wave generated at the top panel 120 is described with reference to FIG. 4.

FIG. 4 is a diagram illustrating crests and troughs of the standing wave formed in parallel with the short side of the top panel 120 included in the standing waves generated at the top panel 120 by the natural vibration at the ultrasound-frequency-band. A part (A) of FIG. 4 illustrates a side view, and a part (B) of FIG. 4 illustrates a perspective view. In parts (A) and (B) of FIG. 4, an XYZ coordinate system similar to that described in FIGS. 2 and 3 is defined. In parts (A) and (B) of FIG. 4, the amplitude of the standing wave is overdrawn in an easy-to-understand manner. The vibrating element 140 is omitted in parts (A) and (B) of FIG. 4.

The natural vibration frequency (the resonance frequency) f of the top panel 120 is represented by formulas (1) and (2) where E is the Young's modulus of the top panel 120, ρ is the density of the top panel 120, δ is the Poisson's ratio of the top panel 120, l is the long side dimension of the top panel 120, t is the thickness of the top panel 120, and k is a periodic number of the standing wave along the direction of the long side of the top panel 120. Since the standing wave has the same waveforms in every half cycle, the periodic number k takes values at 0.5 intervals. The periodic number k takes 0.5, 1, 1.5, 2, . . . .

$$\begin{matrix}f = \frac{π {k}^{2} t}{{l}^{2}} \sqrt{\frac{E}{3 ρ ( 1 - {δ}^{2} )}} & ( 1 ) \\ f = α {k}^{2} & ( 2 )\end{matrix}$$

The coefficient α included in formula (2) corresponds to coefficients other than k² included in formula (1).

A waveform of the standing wave as illustrated in parts (A) and (B) of FIG. 4 is obtained in a case where the periodic number k is 10, for example. In a case where a sheet of Gorilla (registered trademark) glass of which the length l of the long side is 140 mm, the length of the short side is 80 mm, and the thickness t is 0.7 mm is used as the top panel 120, for example, the natural vibration number f is 33.5 kHz, if the periodic number k is 10. In this case, a frequency of the drive signal is 33.5 kHz. In this case, a frequency of the drive signal is 33.5 kHz.

The top panel 120 is a planar member. If the vibrating element 140 (see FIGS. 2 and 3) is driven and the natural vibration at the ultrasound-frequency-band is generated at the top panel 120, the top panel 120 is bent as illustrated in parts (A) and (B) of FIG. 4. As a result, the standing wave is generated at the top panel 120.

In the present embodiment, the single vibrating element 140 is bonded on the surface of the top panel 120 which is located on the negative side in Z axis direction at the location along the short side extending in X axis direction at the positive side in Y axis direction. The electronic device 100 may include two vibrating elements 140. In a case where the electronic device 100 includes two vibrating elements 140, another vibrating element 140 may be bonded on the surface of the top panel 120 which is located on the negative side in Z axis direction at a location along the short side extending in X axis direction at a negative side in Y axis direction. In this case, the two vibrating elements 140 are disposed at locations that are axially symmetric with respect to a center line of the top panel 120 parallel to the two short sides of the top panel 120.

In a case where the electronic device 100 includes two vibrating elements 140, the two vibrating elements 140 are driven in the same phase, if the periodic number k is an integer number. If the periodic number k is an odd number, the two vibrating elements 140 are driven in opposite phase.

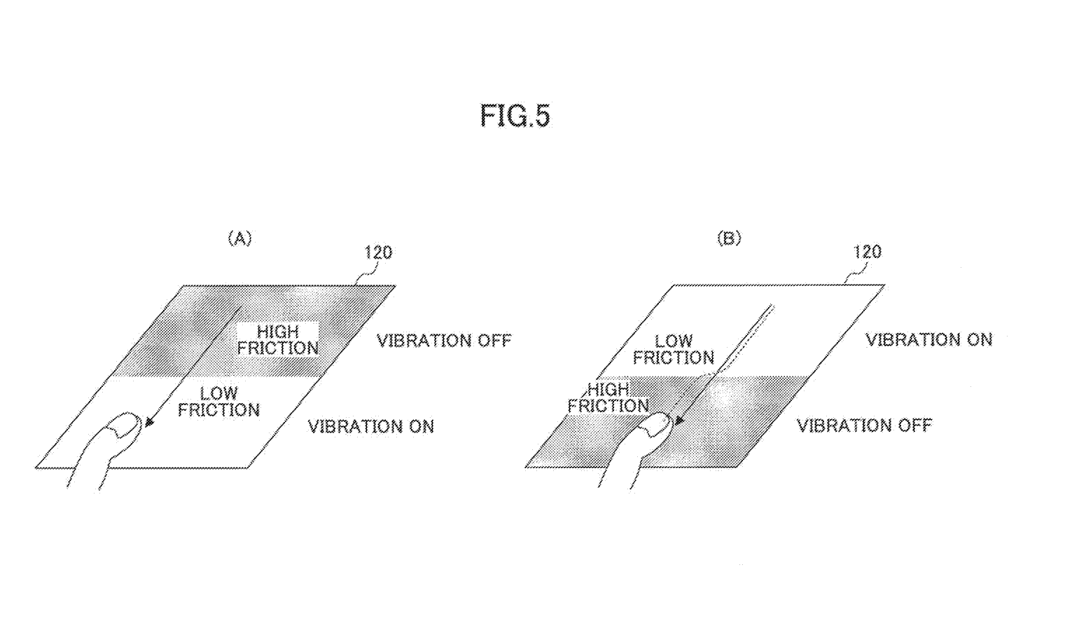

Next, the natural vibration at ultrasound-frequency-band generated at the top panel 120 of the electronic device 100 is described with reference to FIG. 5.

FIG. 5 is a diagram illustrating cases where a kinetic friction force applied to the fingertip varies when the natural vibration at the ultrasound-frequency-band is generated at the top panel 120 of the electronic device 100. In FIG. 5, the manipulation input is performed with the fingertip. In parts (A) and (B) of FIG. 5, the user touches the top panel 120 with the fingertip and performs the manipulation input by tracing the top panel 120 with the fingertip in a direction from a far side to a near side with respect to the user. An on/off state of the vibration is switched by controlling an on/off state of the vibrating element 140 (see FIGS. 2 and 3).

In parts (A) and (B) of FIG. 5, areas in which the fingertip touches while the vibration is being turned off are indicated in grey in the direction from the far side to the near side. Areas in which the fingertip touches while the vibration is being turned on are indicated in white in the direction from the far side to the near side.

As illustrated in FIG. 4, the natural vibration at the ultrasound-frequency-band occurs on an entire surface of the top panel 120. Parts (A) and (B) of FIG. 5 illustrate operation patterns in which the on/off state of the natural vibration is switched while the fingertip of the user is tracing the top panel 120 in the direction from the far side to the near side.

Accordingly, in parts (A) and (B) of FIG. 5, areas in which the fingertip touches while the vibration is being turned off are indicated in grey in the direction from the far side to the near side. Areas in which the fingertip touches while the vibration is being turned on are indicated in white in the direction from the far side to the near side.

In the operation pattern as illustrated in part (A) of FIG. 5, the vibration is turned off when the fingertip of the user is located on the far side of the top panel 120, and the vibration is turned on in the process of tracing the top panel 120 with the fingertip toward the near side.

In the operation pattern as illustrated in part (B) of FIG. 5, the vibration is turned on when the fingertip of the user is located on the far side of the top panel 120, and the vibration is turned off in the process of tracing the top panel 120 with the fingertip toward the near side.

In a state where the natural vibration at the ultrasound-frequency-band is generated at the top panel 120, a layer of air intervenes between the surface of the top panel 120 and the fingertip. The layer of air is provided by a squeeze film effect. As a result, a kinetic friction coefficient on the surface of the top panel 120 is decreased when the user traces the surface with the fingertip.

Accordingly, in the grey area located on the far side of the top panel 120 as illustrated in part (A) of FIG. 5, the kinetic friction force applied to the fingertip becomes larger. In the white area located on the near side of the top panel 120, the kinetic friction force applied to the fingertip becomes smaller.

Therefore, the user who is performing the manipulation input to the top panel 120 in a manner as illustrated in part (A) of FIG. 5 senses a reduction of the kinetic friction force applied to the fingertip when the vibration is turned on. As a result, the user senses a slippery or smooth touch (texture) with the fingertip. In this case, the user senses as if a concave portion is provided on the surface of the top panel 120 when the surface of the top panel 120 becomes slippery and the kinetic friction force becomes lower.

On the contrary, in the white area located on the back side of the top panel 120 as illustrated in part (B) of FIG. 5, the kinetic friction force applied to the fingertip becomes smaller. In the grey area located on the near side of the top panel 120, the kinetic friction force applied to the fingertip becomes higher.

Therefore, the user who is performing the manipulation input to the top panel 120 in a manner as illustrated in part (B) of FIG. 5 senses an increase of the kinetic friction force applied to the fingertip when the vibration is turned off. As a result, the user senses a grippy or scratchy touch (texture) with the fingertip. In this case, the user senses as if a convex portion is provided on the surface of the top panel 120 when the surface of the top panel 120 becomes grippy and the kinetic friction force becomes higher.

Accordingly, the user can sense a concavity or convexity with the fingertip in cases as illustrated in parts (A) and (B) of FIG. 5. For example, “The Printed-matter Typecasting Method for Haptic Feel Design and Sticky-band Illusion” (The collection of papers of the 11^{th} SICE system integration division annual conference (SI2010, Sendai)_174-177, 2010-12) discloses that a human can sense a concavity and a convexity. “Fishbone Tactile Illusion” (Collection of papers of the 10th Congress of The Virtual Reality Society of Japan (September, 2005)) discloses that a human can sense a concavity or a convexity as well.

Although a variation of the kinetic friction force when the vibration is switched on or off is described above, a variation of the kinetic friction force similar to those described above is obtained when the amplitude (intensity) of the vibrating element 140 is varied.

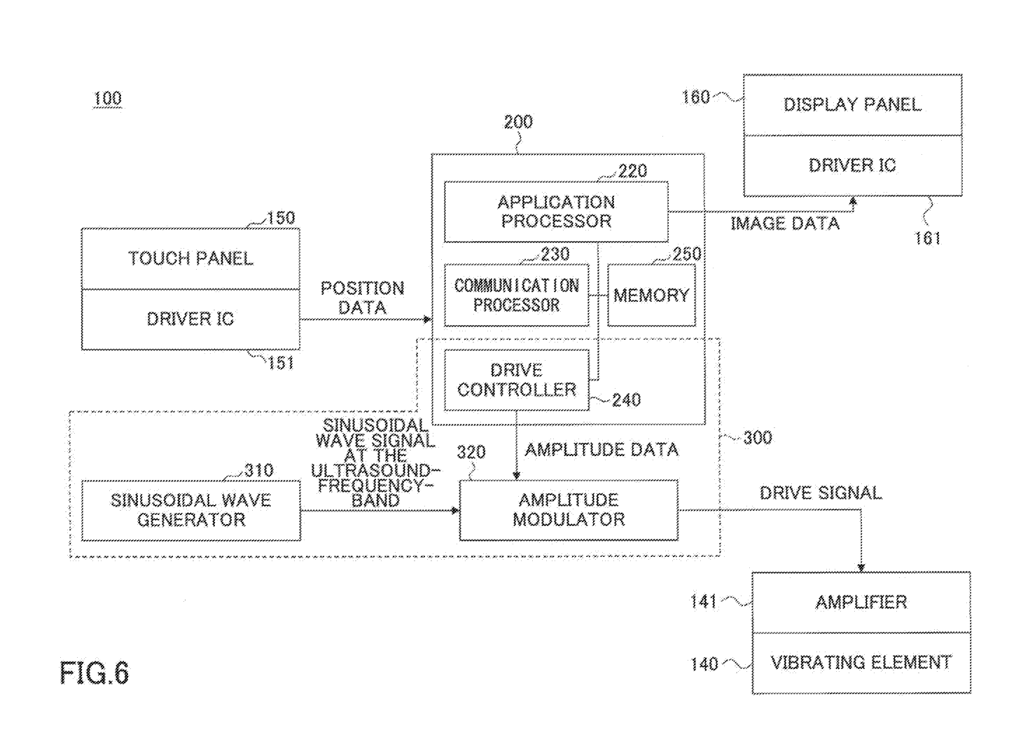

In the following, a configuration of the electronic device 100 according to the embodiment is described with reference to FIG. 6.

FIG. 6 is a diagram illustrating the configuration of the electronic device 100 according to the embodiment.

The electronic device 100 includes the vibrating element 140, an amplifier 141, the touch panel 150, a driver Integrated Circuit (IC) 151, the display panel 160, a driver IC 161, a controller 200, a sinusoidal wave generator 310 and the amplitude modulator 320.

The controller 200 includes an application processor 220, a communication processor 230, a drive controller 240 and a memory 250. The controller 200 is realized by an IC chip, for example.

The drive controller 240, the sinusoidal wave generator 310 and the amplitude modulator 320 constitute a drive control apparatus 300. Although an embodiment in which the application processor 220, the communication processor 230, the drive controller 240 and the memory 250 is included in the single controller 200 is described, the drive controller 240 may be disposed outside of the controller 200 and realized by another IC chip or a processor. In this case, data which is necessary for a drive control performed by the drive controller 240 among data stored in the memory 250 may be stored in another memory disposed in the drive control apparatus 300.

In FIG. 6, the housing 110, the top panel 120, the double-faced adhesive tape 130 and the substrate 170 (see FIG. 2) are omitted. Herein, the amplifier 141, the driver IC 151, the driver IC 161, the drive controller 240, the memory 250, the sinusoidal wave generator 310 and the amplitude modulator 320 are described.

The amplifier 141 is disposed between the drive control apparatus 300 and the vibrating element 140. The amplifier 141 amplifies the drive signal output from the drive control apparatus 300 and drives the vibrating element 140.

The driver IC 151 is connected to the touch panel 150. The driver IC 151 detects position data representing the position on the touch panel 150 at which the manipulation input is performed and outputs the position data to the controller 200. As a result, the position data is input to the application processor 220 and the drive controller 240. Inputting the position data to the drive controller 240 is equal to inputting the position data to the drive control apparatus 300.

The driver IC 161 is connected to the display panel 160. The driver IC 161 inputs image data output from the drive control apparatus 300 to the display panel 160 and displays a picture image to the display panel 160 based on the image data. Accordingly, the GUI input part, the picture image and the like are displayed on the display panel 160 based on the image data.

The application processor 220 executes various application programs included in the electronic device 100.

The communication processor 230 performs processes that are necessary for communications of 3rd Generation (3G), 4th Generation (4G), Long Term Evolution (LTE), WiFi or the like of the electronic device 100.

The drive controller 240 outputs amplitude data to the amplitude modulator 320. The amplitude data represents an amplitude value used for controlling an intensity of the drive signal used for driving the vibrating element 140. The amplitude data representing the amplitude value is stored in the memory 250.

The drive control apparatus 300 of the embodiment causes the top panel 120 to vibrate in order to vary the kinetic friction force applied to the user's fingertip when the fingertip traces along the surface of the top panel 120.

Positions of the GUI input parts displayed on the display panel 160, areas in which picture images are displayed or areas in which entire pages are displayed are identified by area data which represents locations on the display panel 160. The area data is assigned to all the GUI input parts displayed on the display panel 160, all the areas in which the picture images are displayed and all the areas in which entire pages are displayed. The area data is assigned to all the GUI input parts and all the areas that are used in all application programs.

There is a so-called flick operation as a kind of the manipulation input performed by tracing the fingertip(s) touching the surface of the top panel 120. The flick operation is performed in order to operate the GUI input part, for example. The flick operation is performed by flicking (snapping) the fingertip along the surface of the top panel 120 for a relatively-short distance.

The user performs a swipe operation when flipping page(s). The swipe operation is performed by swiping the fingertip along the surface of the top panel 120 for a relatively-long distance. The swipe operation is performed when the user turns over or flips the page or a photo, for example. A drag operation is performed when the user slides the slider (see the slider 102B as illustrated in FIG. 1) which is constituted by the GUI input part.

The manipulation inputs that are performed by tracing the fingertip along the surface of the top panel 120, such as the flick operation, the swipe operation and the drag operation that are introduced as examples, are used differently depending on the kinds of the application programs (software). Accordingly, in a case where the drive control apparatus 300 determines whether the position of the fingertip performing the manipulation input is located in the designated area which requires generating the vibration, the kind (type) of the application program(s) executed by the electronic device 100 is concerned to the determination.

The memory 250 stores the amplitude data representing the amplitude, data representing types of the applications, the area data representing the locations of the GUI input part and the like to which the manipulation input is performed, and the pattern data representing a vibration pattern. In the memory 250, data that is necessary to be associated with each other among the data as described above may be stored in a database table which utilizes identifications and the like, for example.

The memory 250 stores data and programs that are necessary for the application processor 220 to execute the application program and data and programs that are necessary for the communication processor 230 to perform a communication processing.

The sinusoidal wave generator 310 generates sinusoidal waves used for generating the drive signal which causes the top panel 120 to vibrate at the natural vibration number. For example, when causing the top panel 120 to vibrate at a natural vibration frequency f of 33.5 kHz, the frequency of the sinusoidal wave is 33.5 kHz. The sinusoidal wave generator 310 inputs a sinusoidal wave signal at the ultrasound-frequency-band to the amplitude modulator 320.

The amplitude modulator 320 generates the drive signal by modulating an amplitude of the sinusoidal wave signal input form the sinusoidal wave generator 310 based on the amplitude data input from the drive controller 240. The amplitude modulator 320 modulates only the amplitude of the sinusoidal wave signal at the ultrasound-frequency-band input from the sinusoidal wave generator 310 and does not modulate a frequency and a phase of the sinusoidal wave signal in order to generate the drive signal.

Therefore, the drive signal output from the amplitude modulator 320 is a sinusoidal wave signal at the ultrasound-frequency-band obtained by modulating only the amplitude of the sinusoidal wave signal at the ultrasound-frequency-band output from the sinusoidal wave generator 310. In a case where the amplitude data is zero, the amplitude of the drive signal becomes zero. This is the same as that amplitude modulator 320 does not output the drive signal.

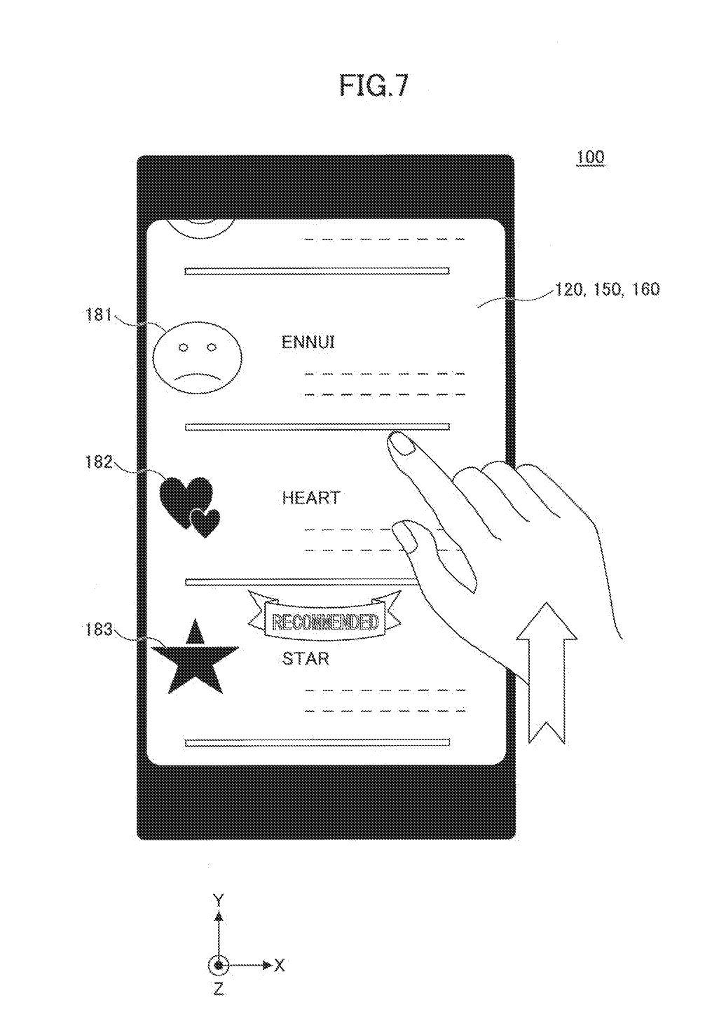

In the following, with reference to FIG. 7, the user's operation performed when the user selects commercial item in a state where the electronic device 100 of the first embodiment displays various commercial items on the display panel 160 is described.

FIG. 7 is a diagram illustrating a state where the electronic device 100 of the first embodiment displays the various commercial items on the display panel 160. FIG. 7 illustrates the top panel 120, the touch panel 150, and the display panel 160 of the electronic device 100. The housing 110 is omitted in FIG. 7. In FIG. 7, an XYZ coordinate system similar to that described in FIGS. 2 to 4 is defined.

In FIG. 7, the electronic device 100 is accessing to a site where the user can buy pictorial symbol(s) via the Internet, and the display panel 160 displays various pictorial symbols (commercial items) that are downloaded from the site.

In FIG. 7, the display panel 160 displays an ennui (bore) face 181, a heart (heart symbol) 182, and a star 183. Descriptions of the pictorial symbols are displayed on the right side of the pictorial symbols, respectively. Data (pictorial symbol data) of each pictorial symbol is downloaded from the site via the Internet, and data representing the description of the pictorial symbol is attached to the pictorial symbol data.

A “recommended” mark which indicates a recommended commercial item is attached to the star 183. Data representing the “recommended” mark is attached to the pictorial symbol data as well.

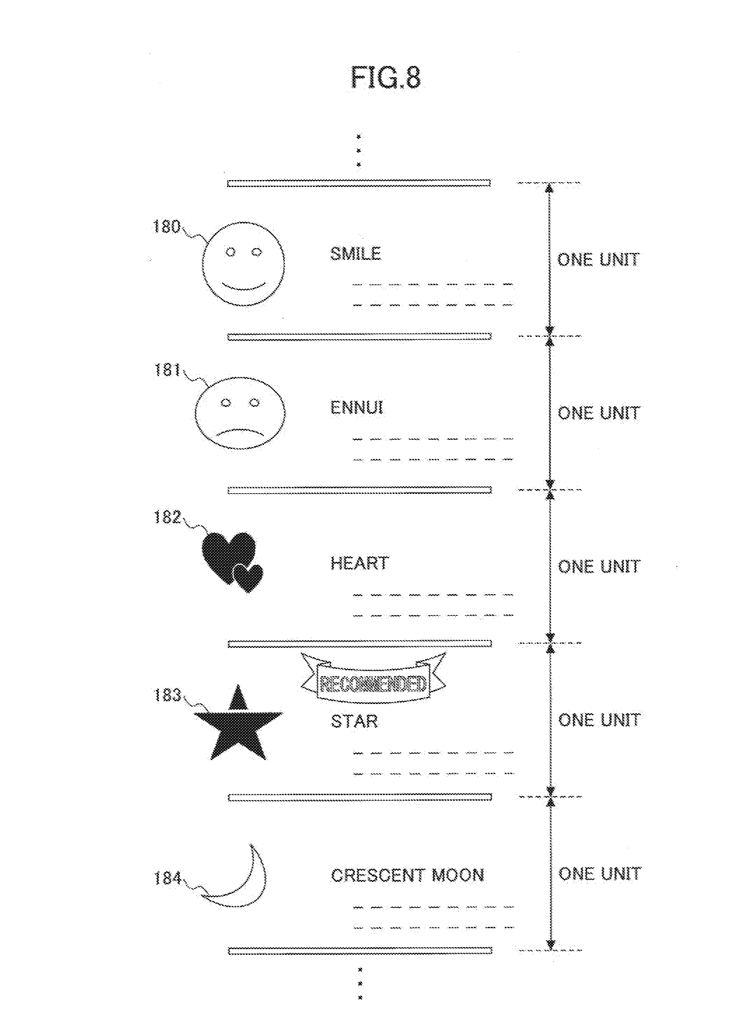

Each pictorial symbol (commercial item) is displayed in a unit-display-area. Hereinafter, the unit-display-area will be described with reference to FIG. 8.

FIG. 8 is a diagram illustrating a list (an enumeration) of the commercial items displayed on the electronic device 100 according to the first embodiment. Although the display panel 160 of the electronic device 100 displays only three pictorial symbols as illustrated in FIG. 7, five pictorial symbols are illustrated in FIG. 8, for the purpose of illustration.

FIG. 8 illustrates a smile face 180, the ennui face 181, the heart 182, the star 183 and a crescent moon 184. Note that FIG. 8 illustrates the pictorial symbols obtained from the pictorial symbol data for the purpose of illustration, and that FIG. 8 does not illustrate a display state in a practical manner.

Herein, the area (the unit-display-area) in which each pictorial symbols are displayed in FIG. 8 is referred to as one unit.

Therefore, the pictorial symbols (the ennui face 181, the heart 182 and the star 183) equivalent of three units are displayed on the display panel 160 of the electronic device 100 as illustrated in FIG. 7.

As illustrated in FIG. 7, the user moves their finger along an arrow in a direction from a negative side in Y axis direction to a positive side in Y axis direction of the display panel 160 while touching the top panel 120 with the fingertip. In this state, the electronic device 100 switches on or off the vibrating element 140 in order to provide a sensation as if concavity and convexity exist on the top panel 120 when a travel distance of the manipulation input reaches a designated travel distance. When the travel distance of the manipulation input reaches a designated distance, the electronic device 100 changes the displayed content equivalent of the one unit.

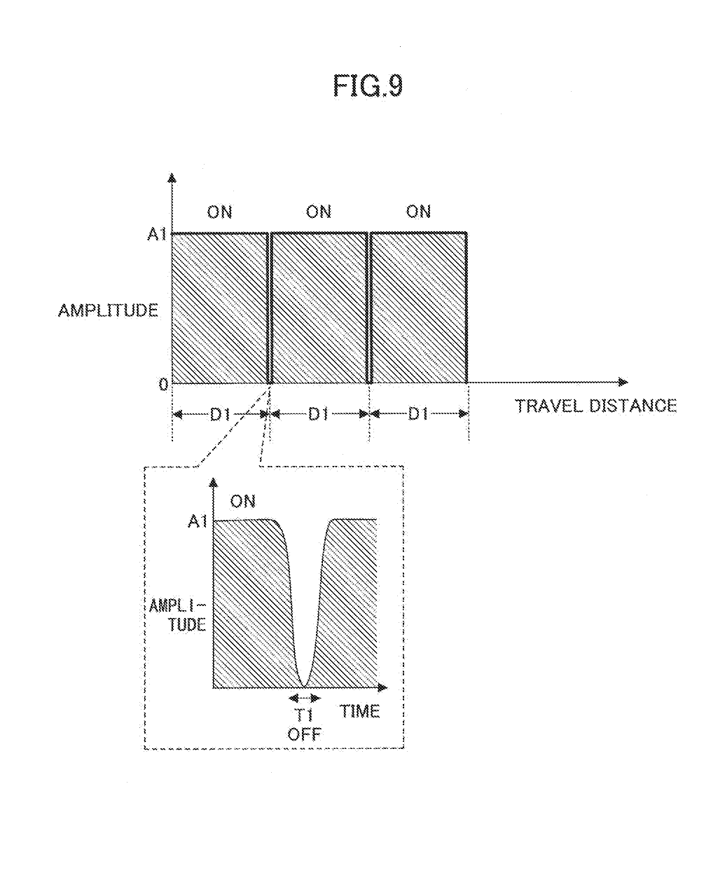

FIG. 9 is a diagram illustrating an operational example of the electronic device 100 according to the first embodiment. In FIG. 9, a horizontal axis indicates the travel distance of the fingertip performing the manipulation input, and a vertical axis indicates the amplitude (amplitude value) of the amplitude data. In an area surrounded by a dashed line in FIG. 9, a part of an operation of the electronic device 100 is enlarged and the horizontal axis is illustrated as a time axis.

According to the electronic device 100, as illustrated in FIG. 9, when the user's fingertip moves while touching the top panel 120, the drive controller 240 drives the vibrating element 140. As a result, the natural vibration is generated on the top panel 120. At this moment, the natural vibration having an amplitude A1 is generated on the top panel 120. In FIG. 9, the user's fingertip which is touching the top panel 120 begins to move when the travel distance increases from zero (0).

The drive controller 240 of the electronic device 100 switches off the vibrating element 140 for a moment every time the travel distance of the fingertip reaches a designated travel distance D1. In other words, the drive controller 240 sets the amplitude of the amplitude data to zero for a moment when the travel distance of the fingertip reaches the designated travel distance D1. If the amplitude data becomes zero, the amplitude of the drive signal output from the amplitude modulator 320 becomes zero. Accordingly, the vibrating element 140 is switched off.

The vibrating element 140 is turned off only for a period of time T1 as illustrated in the area surrounded by the dashed line in FIG. 9. The period of time T1 is, for example, about tens of milliseconds. FIG. 9 illustrates an operational example in which the fingertip is kept traveling and the vibrating element 140 is switched off for three times.

When the vibrating element 140 is switched off, the kinetic friction force applied to the user's fingertip increases. Accordingly, the user feels as if the convexity is provided on the surface of the top panel 120.

For example, if the designated travel distance D1 and a length of the area of the one unit in Y axis direction as illustrated in FIG. 8 are equal to each other, it is possible to provide the sensation of convexity for the user's fingertip and to change the displayed pictorial symbol every time the user's fingertip moves the designated travel distance D1.

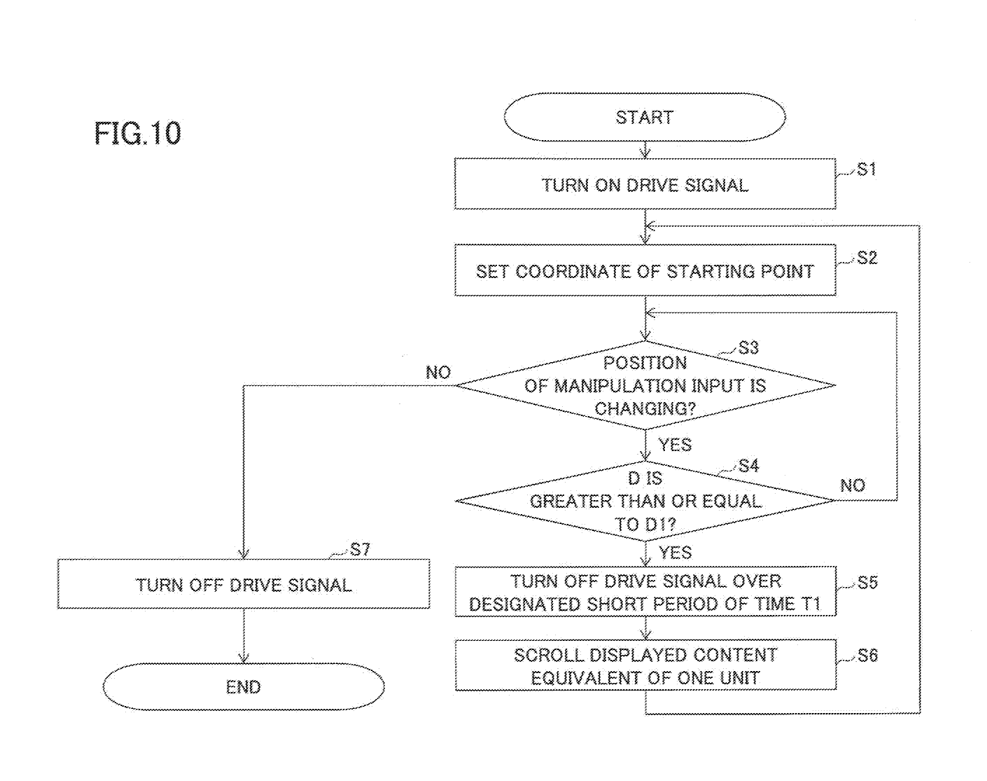

FIG. 10 is a diagram illustrating a flow chart executed by the drive controller 240 of the drive control apparatus 300 included in the electronic device 100 according to the first embodiment.

An operating system (OS) of the electronic device 100 executes drive controls of the electronic device 100 at every designated control cycle. Accordingly, the drive control apparatus 300 performs the processing at every designated control cycle. The same applies to the drive controller 240. The drive controller 240 executes the flows as illustrated in FIG. 10 at every designated control cycle.

Before the flows are started, the application processor 220 causes the display panel 160 to display the pictorial symbols (the ennui face 181, the heart 182, and the star 183) as illustrated in FIG. 7.

If the user's fingertip touches the top panel 120 and begins to move, the drive controller 240 start the processing of the flow (START). Since the position of the user's fingertip touching the top panel 120 is the position of the manipulation input, the processing is started as the position of the manipulation input changes.

Start of the travel of the user's fingertip is determined by the drive controller 240 based on the change of the position data input from the driver IC 151 (see FIG. 6).

The drive controller 240 does not cause the application processor 220 to scroll the displayed content displayed on the display panel 160 at a point in time when the position of the manipulation input begins to change. A point in time when the application processor 220 begins to scroll the displayed content will be described hereinafter.

If the user touches any position on the top panel 120 and begins to move the fingertip, the drive controller 240 starts the processes of the flow regardless of a relationship between the coordinates of the position at which the manipulation input is performed at the beginning and the coordinates of the area in which the commercial item which the user wants to select is displayed.

Next, the drive controller 240 drives the vibrating element 140 in response to the drive signal having the amplitude A1 (step S1). Accordingly, the natural vibration is generated on the top panel 120.

Next, the drive controller 240 sets the coordinates at which the manipulation input has been performed as a starting point (step S2). The position data input from the driver IC 151 (see FIG. 6) at the beginning represents the coordinates at which the manipulation input is started.

Next, the drive controller 240 determines whether the position of the manipulation input is changing (step S3). The drive controller 240 determines whether the position of the manipulation input is changing by determining whether the position data input from the driver IC 151 (see FIG. 6) is changing.

If the drive controller 240 determines that the position of the manipulation input is changing (S3: YES), the drive controller 240 determines whether a travel distance D of the manipulation input reaches the designated travel distance D1 (step S4). Accordingly, the drive controller 240 determines whether D>=D1 is established.

If the drive controller 240 determines that D>=D1 is established (S4: YES), the drive controller 240 turns off the drive signal over a designated short period of time T1 (step S5). For example, the period of time T1 is about tens of milliseconds. Accordingly, the natural vibration of the top panel 120 at the ultrasound-frequency-band is switched off over a very short period of time.

Next, the drive controller 240 causes the application processor 220 to scroll the displayed content equivalent of the one unit (step S6). Accordingly, one pictorial symbol displayed on the display panel 160 is changed to another pictorial symbol. For example, if the manipulation input is performed over the travel distance D1 in positive direction of Y axis in a case where the three pictorial symbols such as the ennui face 181, the heart 182, and the star 183 are displayed on display panel 160 as illustrated in FIG. 7, the ennui face 181 is changed to the crescent moon 184.

Accordingly, the ennui face 181 disappears from the display panel 160 and the crescent moon 184 is displayed on the display panel instead of the ennui face 181.

As described above, if the travel distance D of the user's manipulation input reaches the designated travel distance D1, the natural vibration of the top panel 120 at the ultrasound-frequency-band is switched off over the very short period of time and the displayed content equivalent of the one unit is changed to another.

Accordingly, the user can recognize that the pictorial symbol (commercial item) displayed on the display panel 160 is changed to another based on the sensation applied to the fingertip.

If the drive controller 240 determines that the position of the manipulation input is not changing at step S3 (S3: NO), the drive controller 240 goes to step S7 and turns off the drive signal (step S7). Accordingly, the natural vibration of the top panel 120 is turned off.

The drive controller 240 finishes the processes (END). If the user's fingertip touches the top panel 120 again and begins to move after finishing the processes, the drive controller 240 starts the processing of the flow (START).

If the drive controller 240 determines, at step S4, that the travel distance D of the manipulation input does not reach the designated travel distance D1 (S4: NO), the drive controller 240 returns the flow to step S3.

According to the embodiment as described above, the displayed content displayed on the display panel 160 is not scrolled at the point in time when the position of the manipulation input begins to change. However, the displayed content displayed on the display panel 160 may be scrolled at the point in time when the position of the manipulation input begins to change. The displayed content equivalent of the one unit may be completely switched at a point in time when the travel distance D of the manipulation input reaches the designated travel distance D1, the drive signal is turned off, and the natural vibration of the top panel 120 at the ultrasound-frequency-band is switched off over the short period of time.

Since the kinetic friction force applied to the user's fingertip is varied by generating the natural vibration of the top panel 120 at the ultrasound-frequency-band, the electronic device 100 of the first embodiment can provide a fine or crispy tactile sensation (tactile sense) to the user.

The electronic device 100 of the first embodiment generates the drive signal by causing the amplitude modulator 320 to modulate only the amplitude of the sinusoidal wave at the ultrasound-frequency-band output from the sinusoidal wave generator 310. The frequency of the sinusoidal wave at the ultrasound-frequency-band generated by the sinusoidal wave generator 310 is equal to the natural vibration number of the top panel 120. The natural vibration number is determined in consideration of the weight of the vibrating element 140.

The drive signal is generated at the amplitude modulator 320 by modulating only the amplitude of the sinusoidal wave at the ultrasound-frequency-band generated by the sinusoidal wave generator 310 without modulating the frequency or the phase of the sinusoidal wave.

Accordingly, it becomes possible to generate the natural vibration of the top panel 120 at the ultrasound-frequency-band to the top panel 120 and to reduce the kinetic friction coefficient applied to the fingertip tracing the top panel 120 with absolute accuracy by utilizing the layer of air provided by the squeeze film effect. It becomes possible to provide the fine or crispy tactile sensation as if the concavity or the convexity exists on the surface of the top panel 120 by utilizing the Sticky-band Illusion effect or the Fishbone Tactile Illusion effect to the user.

The electronic device 100 and the drive control apparatus 300 of the first embodiment switch off the natural vibration of the top panel 120 at the ultrasound-frequency-band over the very short period of time T1 and change the displayed content equivalent to the one unit to another, if the travel distance D of the user's manipulation input reaches the designated travel distance D1.

Accordingly, it is possible to provide the electronic device 100 and the drive control apparatus 300 that make the user recognize the changing of the pictorial symbol (commercial item) displayed on the display panel 160 based on the sensation applied to the fingertip.

The designated travel distance D1 may be set to an arbitrary length. The designated travel distance D1 may be set to a length that is equal to a width of the unit-display-area in a direction in which a plurality of the unit-display-areas are arranged or to a length that is close to a width of the one unit. The commercial item is displayed in the unit-display-area in the display panel 160. The length close to the width of the one unit is, for example, in a range of length approximately from 0.8 times to 1.2 times as long as the width. The length equal to the width of the unit-display-area in the arranged direction or the length close to the width of the one unit is a length corresponding to the width of the unit-display-area.

In the embodiment as described above, for the sake of providing the tactile sensation as if the concavity or the convexity is existing on the top panel 120 to the user, the vibrating element 140 is switched on or off. Turning off the vibrating element 140 is equal to setting the amplitude value represented by the drive signal used for driving the vibrating element 140 to zero.

However, it is not necessary to turn off the vibrating element 140 from a being turned on state. For example, instead of switching off the vibrating element 140, the amplitude of the vibration is reduced to a small level. For example, the electronic device 100 may provide the sense as if the concavity or the convexity exists on the surface of the top panel 120 by reducing the amplitude to about one-fifth of that of the turned on state. If the amplitude is set to an amplitude which is not sensed by the user (human), it is possible to obtain an effect similar to that obtained in a case where the vibrating element 140 is switched off.

In this case, the vibrating element 140 is driven by the drive signal in a manner that the vibration of the vibrating element 140 is switched between a strong level and weak level. As a result, the strength of the natural vibration generated to the top panel 120 is switched between the strong level and the weak level. It becomes possible to provide the sense as if the concavity or the convexity exists on the surface of the top panel 120 through the user's fingertip.

If the electronic device 100 switches off the vibrating element 140 when making the vibration weaker in order to switch the vibration of the vibrating element 140 from the strong level to the weak level, the vibrating element 140 is switched off. Switching on and off the vibrating element 140 means driving the vibrating element 140 intermittently.

According to the first embodiment as described above, the drive control apparatus 300, the electronic device 100 and the drive controlling method that can provide the fine or crispy tactile sensation to the user are provided.

According to the embodiment as described with reference to FIG. 9, the drive control apparatus 300 drives the vibrating element 140 and generates the natural vibration on the top panel 120 when the user's fingertip travels. The drive control apparatus 300 switches off the vibrating element 140 when the travel distance of the fingertip reaches the designated distance D1 so as to provide the tactile sensation as if the convexity exists on the top panel 120.

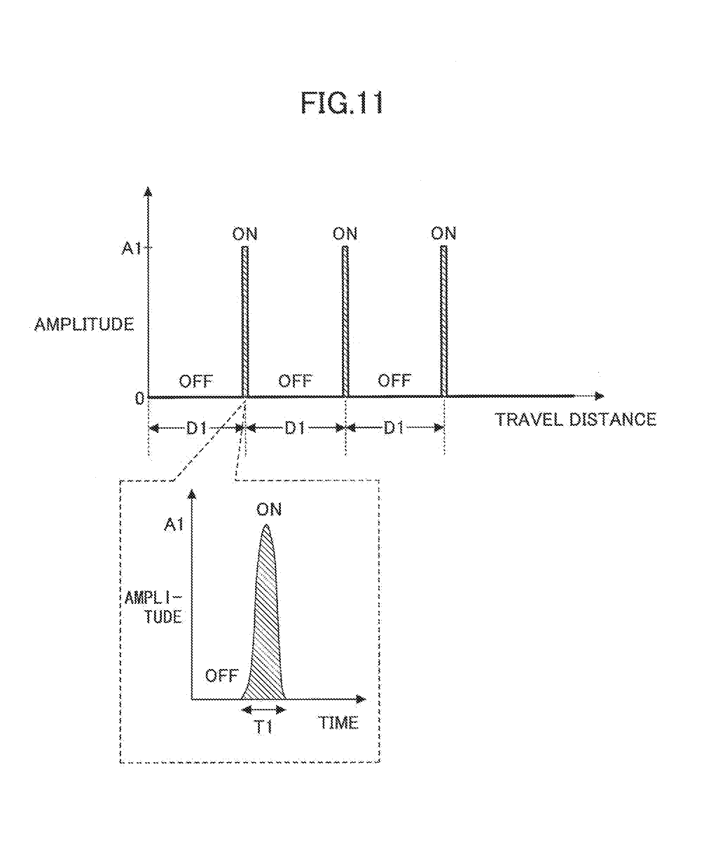

However, the drive control apparatus 300 may not switch on the vibrating element 140 when the user's fingertip touches the top panel 120, and the drive control apparatus 300 switches on and off in an inverted pattern of the driving pattern as illustrated in FIG. 9. FIG. 11 illustrates such a driving pattern.

FIG. 11 is a diagram illustrating an operational example of the electronic device 100 according to a first variational example of the first embodiment. In FIG. 11, a horizontal axis indicates the travel distance of the fingertip performing the manipulation input, and a vertical axis indicates the amplitude (amplitude value) of the amplitude data. In an area surrounded by a dashed line in FIG. 11, a part of an operation of the electronic device 100 is enlarged and the horizontal axis is illustrated as a time axis.

As illustrated in FIG. 11, since the vibrating element 140 is driven in response to the drive signal that switches on and off in the inverted pattern compared with the driving pattern as illustrated in FIG. 9, the vibrating element 140 is switched on over the period of time T1 every time the travel distance D of the manipulation input reaches the designated travel distance D1.

Accordingly, the vibrating element 140 is switched on over the period of time T1 and is switched off at the end of the period of time T1. Therefore, it is possible to provide the sense as if the convexity is existing on the surface of the top panel 120 to the user's fingertip.

In a case where the vibrating element 140 is driven in response to the drive signal having the inverted pattern with respect to that of FIG. 9, it is possible to make the user recognize the changing of the pictorial symbol (commercial item) displayed on display panel 160 through the sensation applied to the user's fingertip.

Since the driving pattern of the drive signal as illustrated in FIG. 11 has longer period of time in which the vibrating element 140 is turned off than that of FIG. 9, it is possible to reduce consumption of power which is necessary for driving the vibrating element 140.

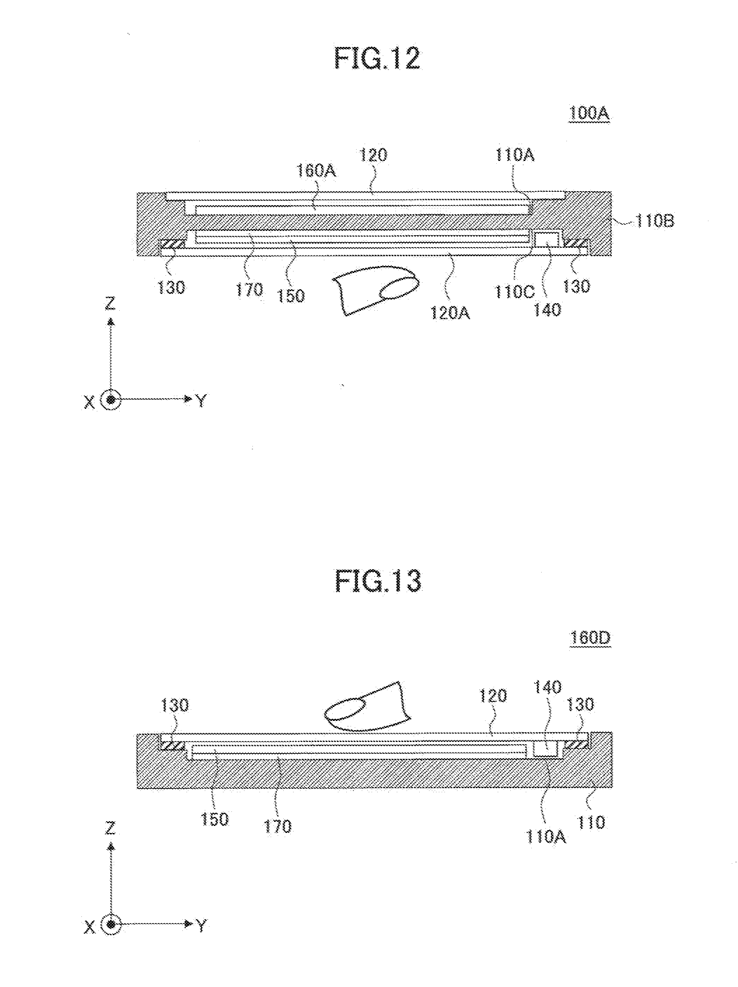

Next, electronic devices 100A and 100C according to second and third variational examples of the first embodiment are described with reference to FIGS. 12 to 14.

FIG. 12 is a diagram illustrating a cross section of the electronic device 100A according to the second variational example of the first embodiment. The cross section as illustrated in FIG. 12 corresponds to a cross section taken along a line A-A as illustrated in FIG. 3. In FIG. 12, an XYZ coordinate system similar to that illustrated in FIG. 3 is defined.

The electronic device 100A includes a housing 110B, a top panel 120, a panel 120A, a double-faced adhesive tape 130, a vibrating element 140, a touch panel 150, a display panel 160A and a substrate 170.

The electronic device 100A has a configuration in which the touch panel 150 is disposed on a back surface side (negative side in Z axis direction) of the electronic device 100 as illustrated in FIG. 3. Therefore, the double-faced adhesive tape 130, the vibrating element 140, the touch panel 150 and the substrate 170 are disposed on the back surface side compared with the electronic device 100 as illustrated in FIG. 3.

The housing 110B has a concave portion 110A located on positive side in Z axis direction and a concave portion 110C located on negative side in Z axis direction. The display panel 160A is disposed in the concave portion 110A and is covered by the top panel 120. The touch panel 150 and the substrate 170 are stacked with each other and are disposed in the concave portion 110C. The panel 120A is adhered to the housing 110B by the double-faced adhesive tape 130. The vibrating element 140 is attached on a positive-side-surface of the panel 120A in Z axis direction.

Since the electronic device 100A, as illustrated in FIG. 12, switches on or off the vibrating element 140 in accordance with the manipulation input performed onto the panel 120A and generates the natural vibration at ultrasound-frequency-band on the panel 120A, it is possible to provide the electronic device 100A that can provide the fine or crispy tactile sensation to the user's fingertip corresponding to the changing of the pictorial symbol (commercial item) displayed on the display panel 160 in a manner similar to the electronic device 100 as illustrated in FIG. 3.

In FIG. 12, the touch panel 150 is provided on the back surface side of the electronic device 100A. However, another touch panel similar to the touch panel 150 may be provided on the front surface side of the electronic device 100A. This configuration is realized by combining the configuration as illustrated in FIG. 3 and the configuration as illustrated in FIG. 12, i.e., the electronic device 100A may include two touch panels.

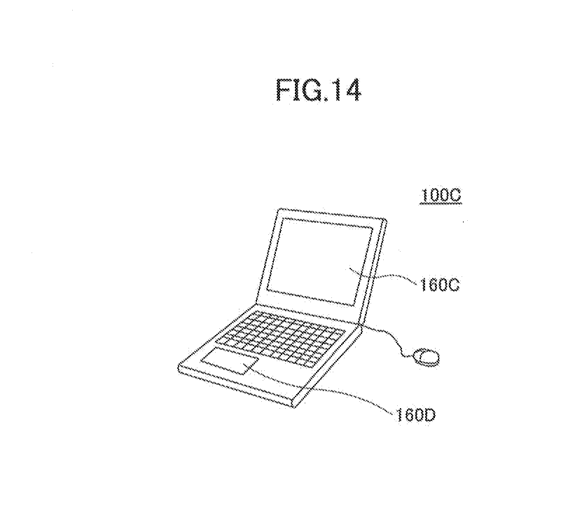

FIG. 14 is a diagram illustrating the electronic device 100C according to the third variational example of the first embodiment. The electronic device 100C is a notebook type personal computer (PC).

The PC 100C includes a display panel 160C and a touch-pad 160D.

FIG. 13 is a diagram illustrating a cross section of the touch-pad 160D of the electronic device 100C according to the third variational example of the first embodiment. The cross section as illustrated in FIG. 13 corresponds to a cross section taken along a line A-A as illustrated in FIG. 3. In FIG. 13, an XYZ coordinate system similar to that illustrated in FIG. 3 is defined.

The touch pad 160D has a configuration obtained by getting rid of the display panel 160 from the electronic device 100 as illustrated in FIG. 3.

According to the third variational example, the electronic device 100C switches on or off the vibrating element 140 in accordance with the manipulation input performed onto the touch-pad 160D and generates the natural vibration in the ultrasound-frequency-band on the top panel 120. It is possible to provide the fine or crispy tactile sensation to the user's fingertip corresponding to travel distance of the manipulation input in a manner similar to the electronic device 100 illustrated in FIG. 3.

Moreover, if the electronic device 100D includes a vibrating element disposed on a back surface side of the display panel 160C, it becomes possible to provide the fine or crispy tactile sensation to the user's fingertip corresponding travel distance of the manipulation input performed on the display panel 160C in a manner similar to the electronic device 100 illustrated in FIG. 3.

### Second Embodiment

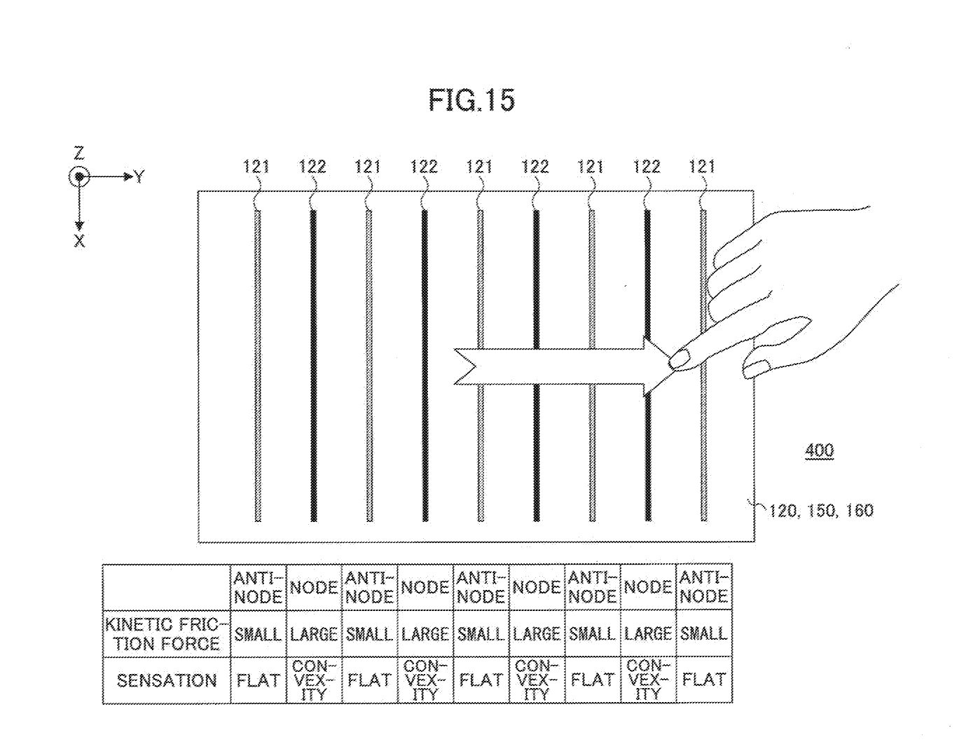

FIG. 15 is a diagram illustrating an electronic device 400 according to the second embodiment in plan view. The electronic device 400 of the second embodiment has a configuration similar to that of the electronic device 100 of the first embodiment. However, a driving method of the vibrating element 140 performed by the drive controller 240 and a method for changing the displayed content on the display panel 160 performed by the application processor 220 are different from those of the electronic device 100 of the first embodiment.

Hereinafter, the electronic device 400 having the configuration similar to that of the electronic device 100 as illustrated in FIG. 6 will be described mainly in accordance with differences. FIG. 15 illustrates positions of the top panel 120, the touch panel 150, and the display panel 160. In FIG. 15, an XYZ coordinate system similar to that described in FIGS. 2 to 4 is defined.

FIG. 15 illustrates antinodes 121 and nodes 122 of the standing wave generated on the top panel 120 of the electronic device 400 by the natural vibration at the ultrasound-frequency-band. In a table illustrated in the bottom of FIG. 15, the kinetic friction force (large or small) on the top panel 120 and the tactile sensation (flat or convexity) at positions of the antinodes 121 and the nodes 122 are described.

As illustrated in the table, the kinetic friction force is small and the tactile sensation is flat at the antinodes 121. The kinetic friction force is large and the tactile sensation is convexity at the nodes 122.

A difference of the kinetic friction force is caused by the squeeze film effect, and a difference of the tactile sensation is caused by the Sticky-band Illusion effect or the Fishbone Tactile Illusion effect.

If the user moves the fingertip touching the touch panel 120 along an arrow in Y axis direction as illustrated in FIG. 15 so that the fingertip traces the standing wave, the user obtains the kinetic friction forces and the tactile sensations as illustrated in the table through the fingertip.

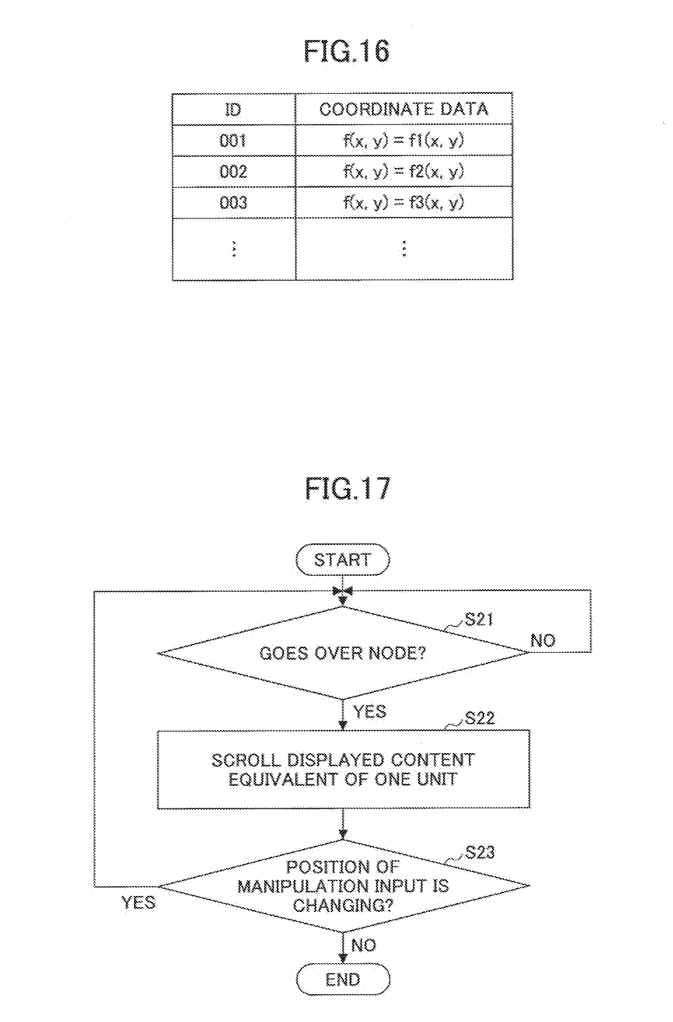

The electronic device 400 of the second embodiment uses coordinate data representing positions of the nodes 122 (see FIG. 15) as illustrated in FIG. 16.

FIG. 16 is a diagram illustrating the coordinate data representing the positions of the nodes 122 used in the electronic device 400 of the second embodiment.

In the second embodiment, the standing wave is generated along a longitudinal direction (Y axis direction) of the top panel 120. As described with reference to FIG. 4, the standing wave is generated on the top panel 120 by driving the vibrating element 140 at the natural vibration frequency (the resonance frequency) which is determined by the Young's modulus E, the density p, the Poisson's ratio 5, the long side dimension 1, the thickness t, and the periodic number k of the standing wave generated along the direction of the long side.

Accordingly, if the long side dimension 1 and the periodic number k are determined, the positions of the antinodes 121 and the nodes 122 are obtained. Therefore, it is possible to obtain the coordinate data representing the positions of the nodes 122.

In FIG. 16, the coordinate data represented as f(x, y)=f1(x, y), f2(x, y), f3(x, y) . . . are allocated to the nodes 122 having identifications (IDs) 001, 002, 003 . . . . The coordinate data represents the positions of the nodes 122 as illustrated in FIG. 15.

The electronic device 400 of the second embodiment uses the coordinate data of the nodes 122 as illustrated in FIG. 16 and executes processes as illustrated in FIG. 17.

FIG. 17 is a diagram illustrating a flowchart executed by the drive controller 240 of the drive control apparatus 300 included in the electronic device 400 according to the second embodiment.

An operating system (OS) of the electronic device 400 executes drive controls of the electronic device 400 at every designated control cycle. Accordingly, the drive control apparatus 300 performs the processing at every designated control cycle. The same applies to the drive controller 240. The drive controller 240 executes the flows as illustrated in FIG. 17 at every designated control cycle.

Before the flows are started, the application processor 220 causes the display panel 160 to display the pictorial symbols (the ennui face 181, the heart 182, and the star 183) as illustrated in FIG. 7.

If the user's fingertip touches the top panel 120 and begins to move, the drive controller 240 starts the processing of the flow (START). Since the position of the user's fingertip touching the top panel 120 is the position of the manipulation input, the processing is started as the position of the manipulation input changes.

Next, the drive controller 240 determines whether the position of the manipulation input goes over the node 122 (step S21). In order to determine whether the position of the manipulation input goes over the node 122, the drive controller 240 determines whether the position of the manipulation input travels from one side to the other side of a line which is represented by the coordinate data of any one of the nodes 122 as illustrated in FIG. 16 and divides the one side and the other side.

The drive controller 240 executes the process of step S21 repeatedly until the drive controller 240 determines that the position of the manipulation input goes over the node 122.

If the drive controller 240 determines that the position of the manipulation input goes over the node 122 (S21: YES), the drive controller 240 causes the application processor 220 to scroll the displayed content equivalent of the one unit (step S22). Accordingly, one pictorial symbol displayed on the display panel 160 is changed to another pictorial symbol. For example, if the manipulation input is performed over the travel distance D1 in positive direction of Y axis in a case where the three pictorial symbols such as the ennui face 181, the heart 182, and the star 183 are displayed on display panel 160 as illustrated in FIG. 7, the ennui face 181 is changed to the crescent moon 184.

If the position of the user's manipulation input goes over the node 122, the displayed content equivalent of the one unit is changed in the display panel 160.

As the user's fingertip touching the top panel 120 goes over the node 122, the tactile sensation as if the convexity exists on the top panel 120 is provided to the user's fingertip. The user can sense that the pictorial symbol (commercial item) displayed on the display panel 160 is changed based on the sensation applied to the fingertip.

Next, the drive controller 240 determines whether the position of the manipulation input is changing (step S23). The drive controller 240 determines whether the position of the manipulation input is changed by determining whether the position data input from the driver IC 151 (see FIG. 6) is changed.

If the drive controller 240 determines that the position of the manipulation input is changing (S23: YES), the drive controller 240 returns the flow to step S21.

If the drive controller 240 determines that the position of the manipulation input is not changing (S23: NO), the drive controller 240 finishes the processes (END).

According to the second embodiment, the electronic device 400 changes the displayed content of the display panel 160 equivalent to the one unit when the user's fingertip goes over the node 122 and the tactile sense of the convexity is provided to the user's fingertip by causing the natural vibration of the top panel 120 at the ultrasound-frequency-band. Therefore, it is possible to provide the fine or crispy tactile sensation to the user when changing the displayed content.

The tactile sensation of the convexity is provided to the user based on the Sticky-band Illusion effect or the Fishbone Tactile Illusion effect that is provided by the decrease of the kinetic friction force caused by the squeeze film effect.

### Third Embodiment

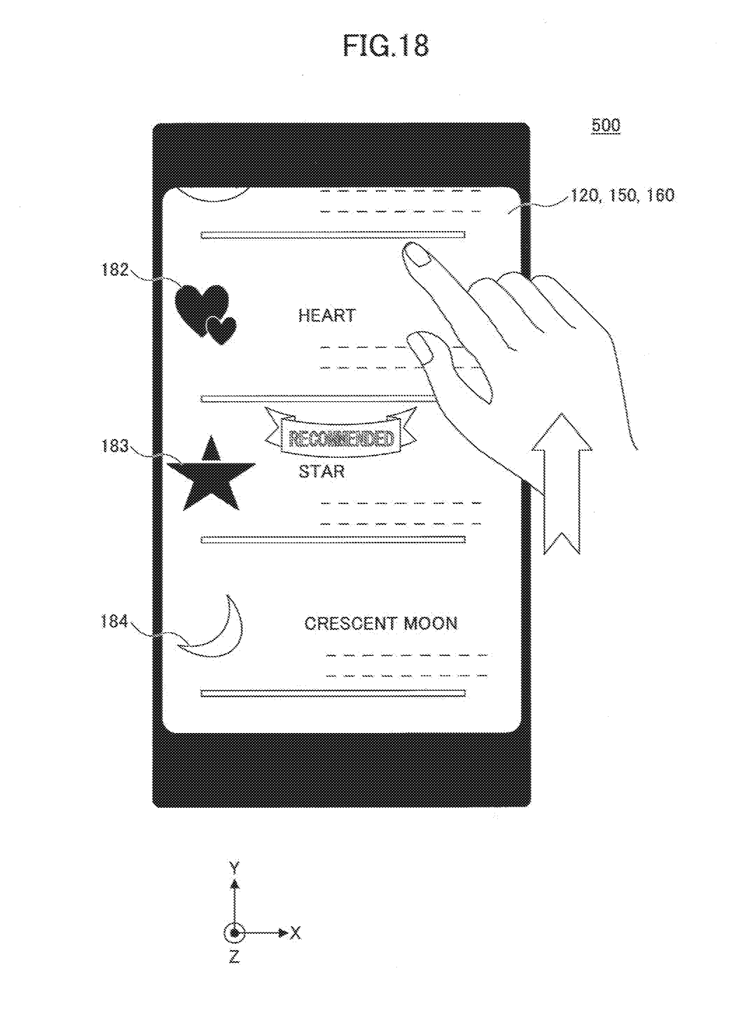

FIG. 18 is a diagram illustrating an electronic device 500 according to the third embodiment in plan view. The electronic device 500 of the third embodiment has a configuration similar to that of the electronic device 100 of the first embodiment. However, a driving method of the vibrating element 140 performed by the drive controller 240 and a method for changing the displayed content on the display panel 160 performed by the application processor 220 are different from those of the electronic device 100 of the first embodiment.

Hereinafter, the electronic device 500 having the configuration similar to that of the electronic device 100 as illustrated in FIG. 6 will be described mainly in accordance with differences. FIG. 18 illustrates positions of the top panel 120, the touch panel 150, and the display panel 160. In FIG. 18, an XYZ coordinate system similar to that described in FIGS. 2 to 4 is defined.

FIG. 18 illustrates the heart 182, the star 183, and the crescent moon 184. These pictorial symbols are the same as those illustrated in FIGS. 7 and 8. Herein, the pictorial symbol of the star 183 is the recommended commercial item.

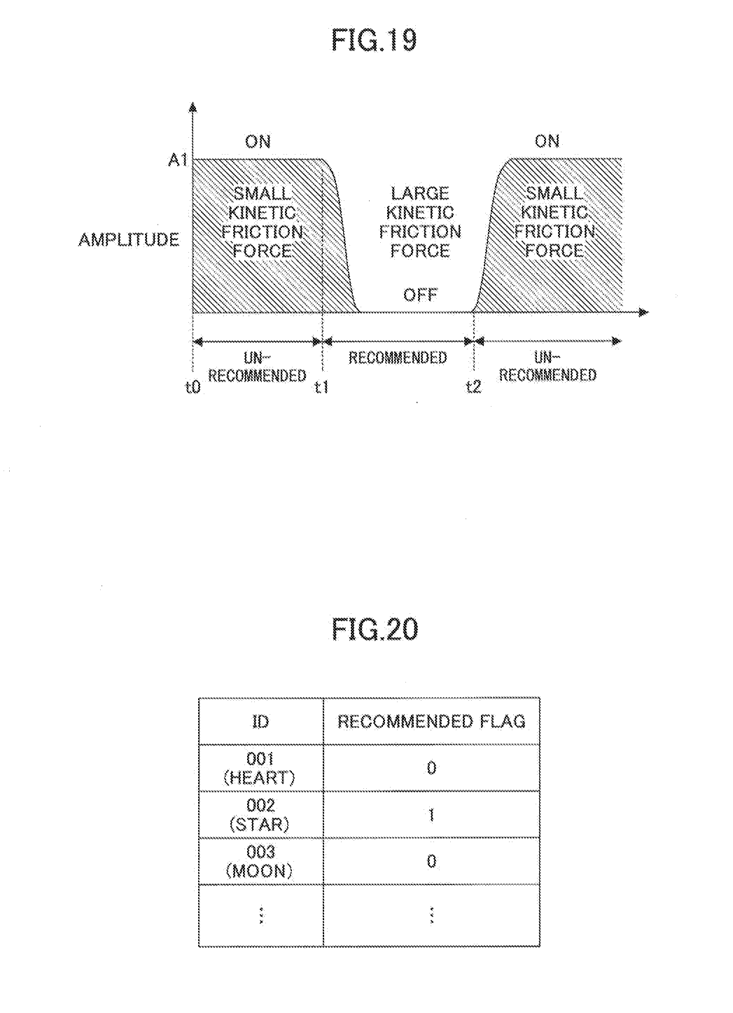

FIG. 19 is a diagram illustrating an operational example of the electronic device 500 according to the third embodiment. In FIG. 19, a horizontal axis indicates time, and a vertical axis indicates the amplitude (amplitude value) of the amplitude data.

As the user's fingertip touches the top panel 120 and begins to move at time to, the electronic device 500 drives the vibrating element 140 and scrolls images displayed on the display panel 160 in response to the travel of the position of the manipulation input. As the position of the manipulation input travels and the recommended commercial item is displayed on the display panel 160 at time t1, the electronic device 500 stops the vibrating element 140. In this case, as the recommended commercial item is displayed on the display panel 160, the electronic device 500 stops the vibrating element 140 regardless of relationship between the position of the manipulation input and a position at which the recommended commercial item is displayed.

As the position of the manipulation input travels further, the recommended commercial item disappears from the display panel 160 at time t2. At time t2, the electronic device 500 begins to drive the vibrating element 140 again.

As the vibrating element 140 is driven (is turned on), the kinetic friction force applied to the fingertip touching the top panel 120 becomes smaller. As the vibrating element 140 is stopped (is turned off), the kinetic friction force applied to the fingertip touching the top panel 120 becomes greater.

According to the third embodiment, the electronic device 500 turns on the vibrating element 140 and makes the kinetic friction force applied to the fingertip smaller so that the fingertip can travel smoothly when only an unrecommended commercial item(s) is displayed on the display panel 160. The unrecommended commercial item is an commercial item that is not recommended to the user. This enhances the scroll operation of the user.

When the recommended commercial item is displayed on the display panel 160, the electronic device 500 turns off the vibrating element 140 and makes the kinetic friction force applied to the fingertip greater so that the recommended commercial item stays longer on the display panel 160.

The electronic device 500 of the third embodiment guides the user's fingertip to the recommended commercial item in a manner as described above.

For example, a state where the star 183 which is the recommended commercial item is not displayed and only the unrecommended commercial items are displayed on the display panel 160 corresponds to a period of time from time t0 to time t1. In this state, the electronic device 500 turns on the vibrating element 140 and makes the kinetic friction force applied to the fingertip touching the top panel 120 smaller. In such a manner as described above, the electronic device 500 enhances the scroll operation.

A state where the star 183 which is the recommended commercial item is displayed on the display panel 160 corresponds to a period of time from time t1 to time t2. In this state, the electronic device 500 turns off the vibrating element 140 and makes the kinetic friction force applied to the fingertip touching the top panel 120 greater so that the recommended commercial item stays longer on the display panel 160.

FIG. 20 is a diagram illustrating commercial item data used in the electronic device 500 according to the third embodiment.

The commercial item data as illustrated in FIG. 20 associates an identification (ID) of the commercial item with a recommended flag. The recommended flag is set to ‘1’ in a case where the commercial item is the recommended commercial item, and the recommended flag is set to ‘0’ in a case where the commercial item is not the recommended commercial item.

The commercial items whose IDs are 001, 002, 003 are the heart 182, the star 183, and the crescent moon 184. In FIG. 20, the recommended flag is set to ‘1’ with reference to the pictorial symbol of the star 183 whose ID is 002. Therefore a sign “recommended” is displayed on the star 183 as illustrated in FIG. 18.

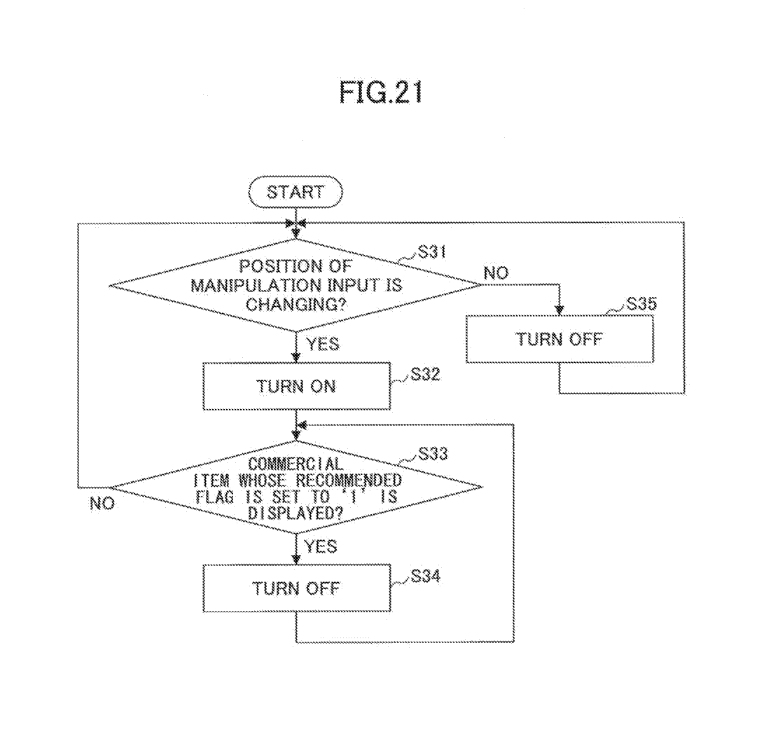

FIG. 21 is a diagram illustrating a flowchart executed by the drive controller 240 of the drive control apparatus 300 included in the electronic device 500 according to the third embodiment.

An operating system (OS) of the electronic device 500 executes drive controls of the electronic device 500 at every designated control cycle. Accordingly, the drive control apparatus 300 performs the processing at every designated control cycle. The same applies to the drive controller 240. The drive controller 240 executes the flows as illustrated in FIG. 21 at every designated control cycle.

The drive controller 240 starts processing when the electronic device 100 is turned on (START).

The drive controller 240 determines whether the position of the manipulation input is changing (step S31)? The drive controller 240 determines whether the position of the manipulation input is changing by determining whether the position data input from the driver IC 151 (see FIG. 6) has changed.

If the drive controller 240 determines that the position of the manipulation input is changing (S31: YES), the drive controller 240 turns on the vibrating element 140 (step S32). Accordingly, the natural vibration at the ultrasound-frequency-band is generated on the top panel 120.

Next, the drive controller 240 determines whether the commercial item whose recommended flag is set to ‘1’ is displayed on the display panel 160 (step S33). At step S33, the drive controller 240 refers to the commercial item data as illustrated in FIG. 20 and determines whether there is the commercial item whose recommended flag is set to ‘1’ among the commercial items displayed on the display panel 160 by the application processor 220.

The drive controller 240 may obtain data representing a type of each of the commercial items displayed on the display panel 160 from the application processor 220. In this case, the drive controller 240 may obtain the ID representing the type of the commercial item from the application processor 220.

If the drive controller 240 determines that the commercial item is one whose recommended flag is set to ‘1’ (S33: YES), the drive controller 240 turns off the vibrating element 140 (step S34). This is for the sake of causing a state where the fingertip stays longer, as described above, by turning off the vibrating element 140 and thereby making the kinetic friction force applied to the fingertip greater, in a case where the commercial item whose recommended flag is set to ‘1’ is displayed.

The drive controller 240 returns the flow to step S33 upon finishing the processes of step S34.

At step S33, if the drive controller 240 determines that the commercial item whose recommended flag is set to ‘1’ is not displayed (S33: NO), the drive controller 240 returns the flow to step S31.

At step S31, if the drive controller 240 determines that the position of the manipulation input has not changed (S31: NO), the drive controller 240 goes to step S35 and turns off the vibrating element 140 (step S35). The drive controller 240 returns the flow to step S31 upon finishing the processes of step S35. The drive controller 240 executes the process of step S31 repeatedly until the drive controller 240 determines that the position of the manipulation input has changed.

Since the kinetic friction force applied to the user's fingertip is varied by generating the natural vibration of the top panel 120 at the ultrasound-frequency-band, the electronic device 500 of the third embodiment can provide a fine or crispy tactile sensation (tactile sense) to the user. Further, the electronic device 500 can guide the user's manipulation input so that a desired commercial item is displayed on the display panel 160.

For the sake of guiding the user's manipulation input so that the desired commercial item is displayed on the display panel 160, the electronic device 500 utilizes a change of the kinetic friction force obtained by the squeeze film effect. Accordingly, the tactile sensations of the concavity and the convexity obtained based on the Sticky-band Illusion effect or the Fishbone Tactile Illusion effect are provided to the user.

A technique described in the third embodiment can be added to techniques of the first and second embodiments. For example, the electronic device 100 of the first embodiment switches off the natural vibration of the top panel 120 at the ultrasound-frequency-band over the very short period of time T1 and changes the displayed content equivalent to the one unit to another, if the travel distance D of the user's manipulation input reaches the designated travel distance D1. In this case, for the sake of guiding the user's manipulation input so that the desired commercial item is displayed on the display panel 160, the electronic device 100 may switch off the vibrating element 140 so that the kinetic friction force applied to the user's fingertip becomes greater when the recommended commercial item is displayed on the display panel 160.

The processes of the third embodiment may be performed in addition to the changing of the displayed content of the display panel 160 equivalent to the one unit when providing the tactile sensation of the convexity to the user's fingertip in a case where the user's fingertip goes over the node 122 in the second embodiment. In this case, for the sake of guiding the user's manipulation input so that the desired commercial item is displayed on the display panel 160, the electronic device 100 may switch off the vibrating element 140 so that the kinetic friction force applied to the user's fingertip becomes greater when the recommended commercial item is displayed on the display panel 160.

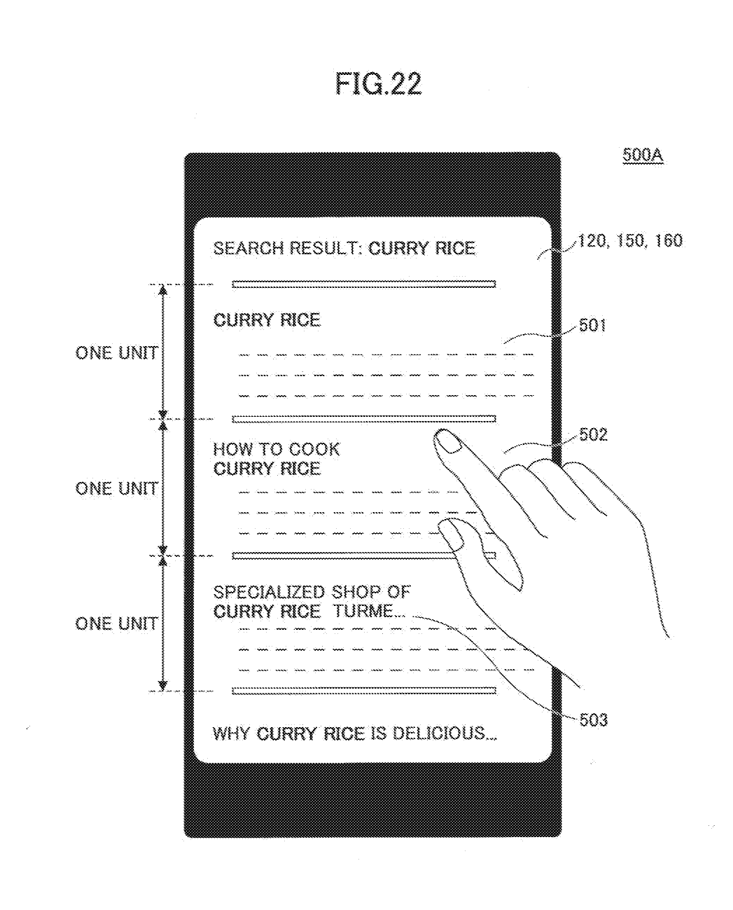

FIG. 22 is a diagram illustrating an electronic device 500A according to a variational example of the third embodiment. Contents other than an advertisement content are displayed in the unit-display-areas 501 and 502 among the unit-display-area 501, 502 and 503 of the display panel 160 of the electronic device 500A. The advertisement content is displayed in the unit-display-area 503.

The electronic device 500A according to the variational example of the third embodiment utilizes an advertisement flag which represents whether the displayed content is an advertisement instead of the recommended flag as illustrated in FIG. 20, and sets the advertisement flag of the unit-display-area displaying the advertisement content to ‘1’. When the unit-display-area 503 displaying the advertisement content is displayed on the display panel 160, the electronic device 500A switches off the vibrating element 140 so that the unit-display-area 503 stays longer in the display panel 160. The electronic device 500A may guide the user to the advertisement content in a manner as described above.

### Fourth Embodiment

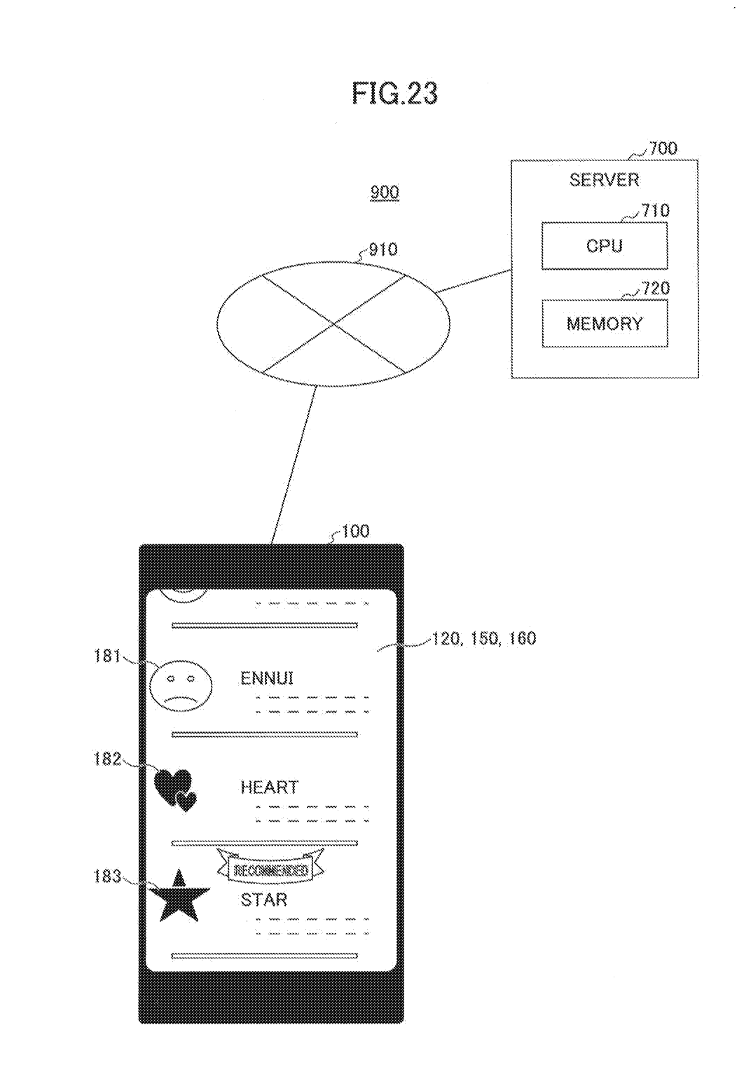

FIG. 23 is a diagram illustrating a system 900 of the fourth embodiment.

The system 900 includes the electronic device 100 and a server 700. The server 700 is an information processing device which includes a Central Processing Unit (CPU) 710 and a memory 720, and is used by a site at which the user buys the pictorial symbol(s). Therefore, the memory 720 stores data of the pictorial symbols.

The electronic device 100 accesses the server 700 via the Internet 910, and displays various pictorial symbols (commercial items) on the display panel 160 that are downloaded from the site.

The user can buy the pictorial symbol downloaded from the server 700 of the site via the Internet 910. In this situation, the server 700 transmits the data of the pictorial symbol to the electronic device 100 in response to a request sent from the electronic device 100 via the Internet 910. Therefore, the electronic device 100 can download the selected pictorial symbol.

According to the embodiments as described above, it becomes possible to provide the drive control apparatus, the electronic device and the drive control method that can provide a fine or crisp tactile sensation to a user.

So far, the preferred embodiments and modification of the semiconductor circuit apparatus and electronic apparatus are described. However, the invention is not limited to those specifically described embodiments and the modification thereof, and various modifications and alteration may be made within the scope of the inventions described in the claims.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiment of the present invention has been described in detail, it should be understood that various changes, substitutions, and alterations could be made hereto without departing from the spirit and scope of the invention.

What is claimed is:

1. A drive control apparatus that drives a vibrating element of an electronic device including a display part, a top panel disposed on a display surface side of the display part and having a manipulation input surface, a position detector detecting a position of a manipulation input performed on the manipulation input surface, and the vibrating element generating a vibration in the manipulation input surface, comprising:
a drive controller configured to drive the vibrating element by using a drive signal causing the vibrating element to generate a natural vibration in an ultrasound-frequency-band in the manipulation input surface, the drive controller being configured to drive the vibrating element so as to switch the natural vibration between a strong level and a weak level for a designated period of time when a travel distance of a position of the manipulation input performed onto the manipulation input surface reaches a designated travel distance.

2. The drive control apparatus as claimed in claim 1, wherein the drive controller switches the natural vibration between the strong level and the weak level for the designated period of time by switching off the drive signal for the designated period of time or by switching on the drive signal for the designated period of time.

3. The drive control apparatus as claimed in claim 1, wherein the designated travel distance corresponds to a length of a displayed area of each of images displayed on the display part.

4. An electronic device comprising:
a display part;
a top panel;
a position detector;
a vibrating element;
a memory configured to store identification data identifying a designated first display image among a plurality of display images displayed on the display part; and
the drive control apparatus as claimed in claim 1,
wherein the drive controller switches an amplitude of the natural vibration to a value less than or equal to a designated amplitude that is not sensed by a human when the display images displayed on the display part are scrolled and the first display image identified by the identification data is displayed on the display part.

5. An electronic device comprising:
a display part;
a top panel disposed on a display surface side of the display part and having a manipulation input surface;
a position detector detecting a position of a manipulation input performed on the manipulation input surface;
a vibrating element generating a vibration in the manipulation input surface;
a drive controller configured to drive the vibrating element by using a drive signal causing the vibrating element to generate a natural vibration in an ultrasound-frequency-band in the manipulation input surface,
a memory configured to store node-position-data representing positions of nodes of a standing wave generated on the manipulation input surface by the natural vibration; and
a display switching part configured to switch a display content displayed on the display part when a position of the manipulation input reaches the position of the node.

6. The electronic device as claimed in claim 5, wherein the memory further stores identification data identifying a designated first display image among a plurality of display images displayed on the display part, and
wherein the drive controller switches an amplitude of the natural vibration to a value less than or equal to a designated amplitude that is not sensed by a human when the display images displayed on the display part are scrolled and the first display image identified by the identification data is displayed on the display part.

7. An electronic device comprising:
a display part;
a top panel disposed on a display surface side of the display part and having a manipulation input surface;
a position detector detecting a position of a manipulation input performed on the manipulation input surface;
a vibrating element generating a vibration in the manipulation input surface;
a drive controller configured to drive the vibrating element by using a drive signal causing the vibrating element to generate a natural vibration in an ultrasound-frequency-band in the manipulation input surface, and
a memory configured to store identification data identifying a designated first display image among a plurality of display images displayed on the display part,
wherein the drive controller switches an amplitude of the natural vibration to a value less than or equal to a designated amplitude that is not sensed by a human when the display images displayed on the display part are scrolled and the first display image identified by the identification data is displayed on the display part.

8. The electronic device as claimed in claim 4, wherein the drive controller switches off the drive signal so as to switch the amplitude of the natural vibration to the value less than or equal to the designated amplitude that is not sensed by the human.

9. The electronic device as claimed in claim 4, wherein the drive signal causes the vibrating element to generate the natural vibration in the ultrasound-frequency-band in the manipulation input surface, the natural vibration having a constant frequency and a constant phase.

10. The electronic device as claimed in claim 4, wherein the manipulation input surface has a rectangular shape having long sides and short sides in plan view, and
wherein the drive controller causes the vibrating element to vibrate so as to generate a standing wave on the manipulation input surface, an amplitude of the standing wave varying along the long side.

11. A system comprising:
the electronic device as claimed in claim 4; and
a server configured to communicate with the electronic device,
wherein the server transmits data of a commercial item that is requested from the electronic device to the electronic device, and
wherein the electronic device displays the display images based on the data received from the server.

12. A drive control method for driving a vibrating element of an electronic device including a display part, a top panel disposed on a display surface side of the display part and having a manipulation input surface, a position detector detecting a position of a manipulation input performed on the manipulation input surface, and the vibrating element generating a vibration in the manipulation input surface, comprising:
driving, by a computer, the vibrating element by using a drive signal causing the vibrating element to generate a natural vibration in an ultrasound-frequency-band in the manipulation input surface, the driving being configured to drive the vibrating element so as to switch the natural vibration between a strong level and a weak level for a designated period of time when a travel distance of a position of the manipulation input performed onto the manipulation input surface reaches a designated travel distance.
